(19) United States
(12) Patent Application Publication
(10) Pub. No.: US 2026/0119843 A1
(43) Pub. Date: Apr. 30, 2026

(54) SPATIALLY AWARE COLOR CONDITIONING FOR DIFFUSION NEURAL NETWORKS

(71) Applicant: Adobe Inc., San Jose, CA (US)

(72) Inventors: Vlad-Constantin Lungu-Stan, Bucharest (RO); Hareesh Ravi, San Jose, CA (US); Sachin Kelkar, Santa Clara, CA (US); Ionut Mironica, Bucharest (RO)

(21) Appl. No.: 18/925,604

(22) Filed: Oct. 24, 2024

(51) Int. Cl. G06N 3/0475; G06T 7/13; G06T 11/00; G06V 10/75; G06V 10/82

(52) U.S. Cl. CPC G06N 3/0475; G06T 7/13; G06T 11/10; G06V 10/751; G06V 10/82

(57) ABSTRACT

The present disclosure relates to systems, non-transitory computer-readable media, and methods for generating synthesized digital images through a conditioned diffusion neural network utilizing an image prompt and a color conditioning input. In some embodiments, the disclosed systems receive an image prompt containing a text description of a digital image and a color conditioning input defining the position of a certain color value from a client device. In some embodiments, the disclosed systems condition a diffusion neural network using the color conditioning input and use the conditioned diffusion neural network to process the image prompt to generate a synthesized digital image correlating with the image prompt and the color conditioning input. In some embodiments, the disclosed systems provide the synthesized digital image for display on a client device.

### BACKGROUND

In the field of digital image generation, diffusion models exhibit superior quality over other model architectures, such as generative adversarial networks (“GANs”) and variational autoencoders (“VAEs”). Besides the generative power of diffusion models, another feature that sets them apart from GANs, VAEs, and other image generation solutions is their fine-grained control. Using text-based prompts, diffusion models are capable of steering toward generating images across a wide array of domains and subject matters, even without specialized training for each available class or topic. Despite the advancements and the advantages of diffusion models, existing diffusion-model-based systems exhibit a number of drawbacks or disadvantages, particularly regarding precise color and position generation.

### SUMMARY

This disclosure describes one or more embodiments of systems, methods, and non-transitory computer readable media that solve one or more of the foregoing or other problems in the art by conditioning a diffusion neural network using a color control adapter to condition on spatially aware color information. For example, the disclosed systems condition a diffusion neural network on a color conditioning input defining precise color values at specific pixel coordinates. In some embodiments, the disclosed systems generate synthesized digital images using the conditioned neural network to generate pixels matching (or otherwise guided by) the color and location of pixels in the color conditioning input. In some embodiments, the disclosed systems train a diffusion neural network according to color conditions using a unique training image preparation process. Based on such training, in one or more embodiments, the disclosed systems generate synthesized digital images conditioned on spatially aware colors for a variety of domains, including text effects, chart effects, textures, and other image generation.

### BRIEF DESCRIPTION OF THE DRAWINGS

The disclosure describes one or more embodiments of the invention with additional specificity and detail by referencing the accompanying figures. The following paragraphs briefly describe those figures, in which:

FIG. 1 illustrates a diagram of an environment in which a digital content editing system operates in accordance with one or more embodiments.

FIG. 2 illustrates an overview of generating a digital image using a color conditioning input and an image prompt in accordance with one or more embodiments.

FIGS. 3A-3B illustrate example diagrams of generating a digital image with an object placed in a certain location correlating with a color conditioning input in accordance with one or more embodiments.

FIG. 4 illustrates an example diagram of generating a digital image corresponding to a template image in accordance with one or more embodiments.

FIG. 5 illustrates an example diagram of generating a digital image with a set shape and a set color in accordance with one or more embodiments.

FIGS. 6A-6B illustrate example diagrams of generating digital images with design elements with set edges by the use of padded edges in accordance with one or more embodiments.

FIG. 7 illustrates an example diagram of generating a textured digital image by inputting luminance as jitter in accordance with one or more embodiments.

FIG. 8 illustrates an example diagram of a training environment for training a diffusion neural network in accordance with one or more embodiments.

FIG. 9 illustrates an example diagram of generating training super-pixel images for training a diffusion neural network in accordance with one or more embodiments.

FIG. 10 illustrates an example schematic diagram of a digital image generation system in accordance with one or more embodiments.

FIG. 11 illustrates an example flowchart of a series of acts for generating a synthesized digital image from an image prompt and a color conditioning input in accordance with one or more embodiments.

FIG. 12 illustrates an example flowchart of a series of acts for training a diffusion neural network in accordance with one or more embodiments.

FIG. 13 illustrates an example of a guided diffusion model according to aspects of the present disclosure.

FIG. 14 illustrates an example of a U-Net according to aspects of the present disclosure.

FIG. 15 illustrates an example of a method for conditional media generation according to aspects of the present disclosure.

FIG. 16 illustrates a diffusion process according to aspects of the present disclosure.

FIG. 17 illustrates a flow diagram depicting an algorithm as a step-by-step procedure for training a machine-learning model according to aspects of the present disclosure.

FIG. 18 illustrates an example of a method for training a diffusion model according to aspects of the present disclosure.

FIG. 19 illustrates an example of a computing device according to aspects of the present disclosure.

FIG. 20 illustrates an example of a digital image generation apparatus according to aspects of the present disclosure.

### DETAILED DESCRIPTION

This disclosure describes one or more embodiments of a conditioned image generation system that generates digital images using a diffusion neural network that processes an image prompt and a color conditioning input. For example, the conditioned image generation system conditions a diffusion neural network using a color control adapter to modify network parameters such that the diffusion neural network generates or synthesizes an output image that depicts pixels matching the color of the color conditioning input in the same location (e.g., pixel coordinates) of the color conditioning input. To facilitate such spatially aware color conditioning, in certain cases, the conditioned image generation system utilizes a color conditioning input that is generic (so as not to constrain the diffusion neural network too much), easy to create (for fewer than a threshold number of user interactions), partial (leaving room for the diffusion neural network to fill in unspecified pixels), and easily sourced for training data. In some embodiments, the conditioned image generation system generates a synthesized digital image in one of a variety of modes or contexts, such as: 1) keeping or preserving the color and location of pixels in a color conditioning input, 2) removing or omitting pixels according to a color conditioning input, 3) controlling the color of generated objects by preserving detected edges along with color and location of a color conditioning input, 4) generating design elements (e.g., text effects and chart effects), and 5) generating texture images.

In one or more embodiments, the conditioned image generation system receives both an image prompt and a color conditioning input. Based on the color conditioning input, the conditioned image generation system uses a diffusion neural network to generate a synthesized digital image that depicts a scene and/or objects corresponding to the image prompt using pixels colored (at pixel coordinates) according to the color conditioning input. In some cases, the conditioned image generation system conditions the diffusion neural network on the color conditioning input by using a color control adapter to adjust or modify internal parameters at one or more layers of the diffusion neural network, thus conditioning how the layers and neurons process and pass data to ultimately generate a synthesized digital image with pixels portraying precise color values at indicated pixel coordinates or locations.

As mentioned, in some embodiments, the conditioned image generation system trains a diffusion neural network using spatially aware color conditions. For example, the conditioned image generation system trains the diffusion neural network using a conditional training process that involves predicting a noise vector for a color-conditioned training image, comparing (e.g., via a loss function) the predicted noise vector to an actual noise vector added to the color-conditioned training image, and modifying parameters accordingly (e.g., to reduce a measure of loss from the loss function). To facilitate such a training process, in some embodiments, the conditioned image generation system generates a library of color-conditioned training images by modifying digital images using an image augmentation process described in further detail with reference to the figures.

Although conventional systems generate images through the use of diffusion models, such systems have a number of problems or inadequacies in relation to accuracy and flexibility. For instance, conventional systems inaccurately generate images when given specific text inputs corresponding to placement of objects within digital images. To illustrate, conventional systems, when given an input such as “a drink sitting on the left side of a bar,” generate an image with the bar sitting on the middle or right side of the bar. Further, conventional systems inaccurately generate colors for images, even when given specific text inputs specifying the name of the color for an object to generate. To illustrate, when given an input such “generate an image of a blood orange car” or “generate an image of a car with RGB values (195, 73, 70),” conventional systems often generate images of cars with a variety of orange values that do not match the indicated color label or the precise color values.

Additionally, conventional systems are inflexible. For instance, conventional systems are often limited to generating images that generally, but not precisely, adhere to prompt guidelines. To illustrate, some conventional systems generate digital image for text prompts using a one-size-fits-all approach that remains fixed regardless of the use case or context. Thus, when generating text graphics, visual charts, or other images, many existing systems irrespectively apply the same logic with the same models which results in generic, imprecise outputs.

Further, conventional systems are inefficient. For instance, some conventional systems require high-definition images as input. Such systems often require excessive numbers of interactions to generate highly detailed images as input to guide generative models. Not only is requiring so many interactions to generate an input image inefficient in terms of user interactions, but in some cases, conventional systems exhibit increased memory consumption and slower computation as well, especially when processing the excessive interactions and/or working with large numbers of high-resolution images in downstream processes.

As suggested, the conditioned image generation system provides several advantages and benefits over conventional systems. For example, by using a color conditioning input, the conditioned image generation system improves accuracy relative to conventional systems. Specifically, by using a color conditioning input that defines a color and a placement of an object, the conditioned image generation system conditions a diffusion neural network to place a synthesized object in an output image according to the placement. In addition, by using a color conditioning input, the conditioned image generation system colors objects in the synthesized digital image according to the specific color in the color conditioning input. By so doing, the conditioned image generation system more accurately generates digital images relative to conventional systems, especially relating to precise color and specific placement of objects.

The conditioned image generation system also improves flexibility relative to conventional systems. Specifically, by using a color conditioning input, together with other context-specific conditions, the conditioned image generation system adapts to generating synthesized digital images in a variety of contexts. For instance, the conditioned image generation system generates images for text effect or graph effect, allowing the conditioned image generation system to generate text effects, graph effects, textures, and/or based on edge conditions, depending on how the conditioned image generation system augments color conditioning with additional conditioning components. By using different supplemental conditioning inputs together with the color conditioning input, the conditioned image generation system can flexibly generate different types of digital images that conventional systems are unable to generate.

The conditioned image generation system also improves efficiency relative to conventional systems. Specifically, by generating and using super-pixel images using a computationally inexpensive super pixel algorithm, the conditioned image generation system preserves computational resources compared to prior systems. Instead of requiring excessive user interactions to generate entire high-definition images as input, the conditioned image generation system utilizes simple, partial super-pixel images that are computationally inexpensive and fast to generate (requiring far fewer user interactions). Therefore, the conditioned image generation system utilizes less memory and has faster computation relative to conventional systems when processing user interactions to generate input images.

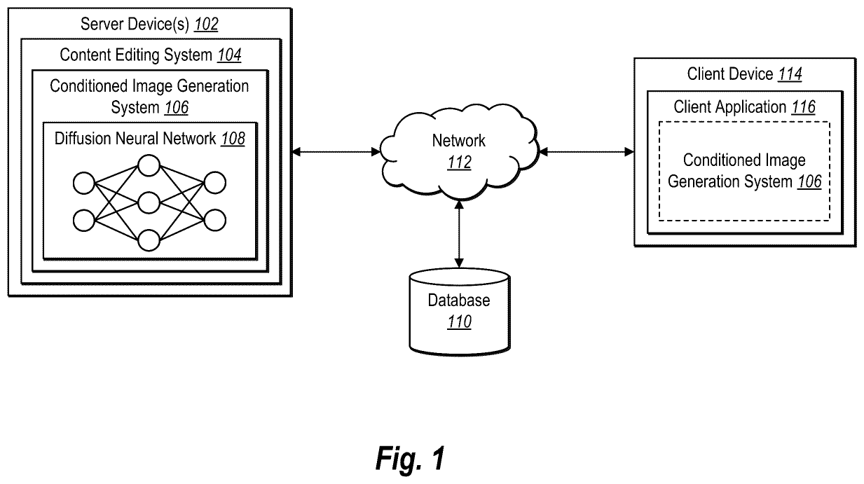

Additional detail regarding the conditioned image generation system will now be provided with reference to the figures. For example, FIG. 1 illustrates a schematic diagram of an example system environment for implementing a conditioned image generation system 106 in accordance with one or more embodiments. An overview of the conditioned image generation system 106 is described in relation to FIG. 1. Thereafter, a more detailed description of the components and processes of the conditioned image generation system 106 is provided in relation to the subsequent figures.

As shown, the environment includes server device(s) 102, a database 110, a network 112, and a client device 114. Each of the components of the environment communicate via the network 112, and the network 112 is any suitable network over which computing devices communicate.

As mentioned, the environment includes a client device 114. The client device 114 is one of a variety of computing devices, including a smartphone, a tablet, a smart television, a desktop computer, a laptop computer, a virtual reality device, an augmented reality device, or another computing device. The client device 114 communicates with the server device(s) 102 via the network 112. For example, the client device 114 provides information to server device(s) 102 indicating client device interactions (e.g., digital image selections, text prompts for generating digital image, requests to modify digital image, or other input) and receives information from the server device(s) 102 such as generated synthesized digital images. Thus, in some cases, the conditioned image generation system 106 on the server device(s) 102 provides and receives information based on client device interaction via the client device 114.

As shown in FIG. 1, the client device 114 includes a client application 116. In particular, the client application 116 is a web application, a native application installed on the client device 114 (e.g., a mobile application, a desktop application, etc.), or a cloud-based application where all or part of the functionality is performed by the server device(s) 102. Based on instructions from the client application 116, the client device 114 presents or displays information to a user, including digital images. In some cases the client application 116 includes a version of the conditioned image generation system 106.

As illustrated in FIG. 1, the environment includes the server device(s) 102. The server device(s) 102 generates, tracks, stores, processes, receives, and transmits electronic data, such as image prompts (e.g., text prompts), sample digital images, color conditioning inputs, generated synthesized digital images, and/or supplemental conditioning inputs. The server device(s) 102, for example, receives data from the client device 114 in the form of an indication of a client device interaction (e.g., a text prompt and a color conditioning input) to generate a synthesized digital image from the client device interaction. In response, the server device(s) 102 transmits data to the client device 114 to display or present a synthesized digital image based on the client device interaction.

In some cases, an image prompt refers to a text description input by a client device and provided to a neural network (e.g., a large language model or a diffusion neural network) to guide or instruct its generative process. In particular, an image prompt can include a plain text description of a proposed digital image to be generated. To illustrate, an image prompt can include a plain text description of objects, colors, backgrounds, text elements, textures, and graphical elements to be generated.

Further, in some embodiments, a color conditioning input refers to a colored template image that conditions the generative process of a neural network, such as a diffusion neural network. In particular, a color conditioning input can include a colored region for a particular element of a requested digital image. To illustrate, a color conditioning input can include a region of colored pixels at a specific location (e.g., where the color and region correspond to a requested element in an image prompt) and/or a template image with a color scheme and a text region.

In some embodiments, the server device(s) 102 communicates with the client device 114 to transmit and/or receive data via the network 112, including client device interactions, digital image generation requests, digital images, and/or other data. In some embodiments, the server device(s) 102 comprises a distributed server where the server device(s) 102 includes a number of server devices distributed across the network 112 and located in different physical locations. The server device(s) 102 comprise a content server, an application server, a communication server, a content editing server, a web-hosting server, a multidimensional server, and/or a machine learning server. The server device(s) 102 further access and utilize the database 110 to store and retrieve information such as stored digital images, and color conditioning data, all or part of the diffusion neural network 108, and/or other data.

As further shown in FIG. 1, the server device(s) 102 also includes the conditioned image generation system 106 as part of a content editing system 104. For example, in one or more implementations, the content editing system 104 is able to store, generate, modify, edit, enhance, provide, distribute, and/or share digital content, such as digital images. For example, the content editing system 104 provides tools for the client device 114, via the client application 116, to generate synthesized digital images utilizing the diffusion neural network 108.

In one or more embodiments, a neural network includes or refers to a machine learning model that is trainable and/or tunable based on inputs to generate predictions, determine classifications, or approximate unknown functions. For example, a neural network includes a model of interconnected artificial neurons (e.g., organized in layers) that communicate and learn to approximate complex functions and generate outputs (e.g., digital images) based on a plurality of inputs provided to the neural network. In some cases, a neural network refers to an algorithm (or set of algorithms) that implements deep learning techniques to model high-level abstractions in data. For example, a neural network includes a deep neural network, a convolutional neural network, a recurrent neural network (e.g., an LSTM), a graph neural network, a transformer, or a generative neural network (e.g., a generative adversarial neural network or a diffusion neural network).

For example, a diffusion neural network includes or refers to a type of generative neural network that utilizes a process involving diffusion and denoising to generate a digital image or a digital design. For example, a diffusion neural network adds noise to a prompt vector to generate a noise map or inversion (e.g., a representation of the digital image with added noise). In some implementations, the diffusion neural network utilizes a conditioning mechanism (e.g., a color conditioning input) to condition the denoising layers for adding edits or modifications in generating a digital design from the noise map/inversion.

In one or more embodiments, the server device(s) 102 includes all, or a portion of, the conditioned image generation system 106. For example, the conditioned image generation system 106 operates on the server device(s) 102 to generate and provide synthesized digital images. In some cases, the conditioned image generation system 106 utilizes, locally on the server device(s) 102 or from another network location (e.g., the database 110), a diffusion neural network 108 to generate synthesized. In addition, the conditioned image generation system 106 includes or communicates with a diffusion neural network 108 for implementation and training.

In certain cases, the client device 114 includes all or part of the conditioned image generation system 106. For example, the client device 114 generates, obtains (e.g., downloads), or utilizes one or more aspects of the conditioned image generation system 106 from the server device(s) 102. Indeed, in some implementations, as illustrated in FIG. 1, the conditioned image generation system 106 is located in who or in part on the client device 114. For example, the conditioned image generation system 106 includes a web hosting application that allows the client device 114 to interact with the server device(s) 102. To illustrate, in one or more implementations, the client device 114 accesses a web page supported and/or hosted by the server device(s) 102.

In one or more embodiments, the client device 114 and the server device(s) 102 work together to implement the conditioned image generation system 106. For example, in some embodiments, the server device(s) 102 train one or more neural networks (e.g., the diffusion neural network 108) discussed herein and provide the one or more neural networks to the client device 114 for implementation. In some embodiments, the server device(s) 102 train one or more neural networks, the client device 114 request design edits, the server device(s) 102 generate modified synthesized digital images utilizing the one or more neural networks. Furthermore, in some implementations, the client device 114 assists in training one or more neural networks.

Although FIG. 1 illustrates a particular arrangement of the environment, in some embodiments, the environment has a different arrangement of components and/or may have a different number or set of components altogether. For instance, as mentioned, the conditioned image generation system 106 is implemented by (e.g., located entirely or in part on) the client device 114, as shown in 118. In addition, in one or more embodiments, the client device 114 communicates directly with the conditioned image generation system 106, bypassing the network 112. Further, in some embodiments, the diffusion neural network 108 includes one or more components stored in the database 110, maintained by the server device(s) 102, the client device 114, or a third-party device.

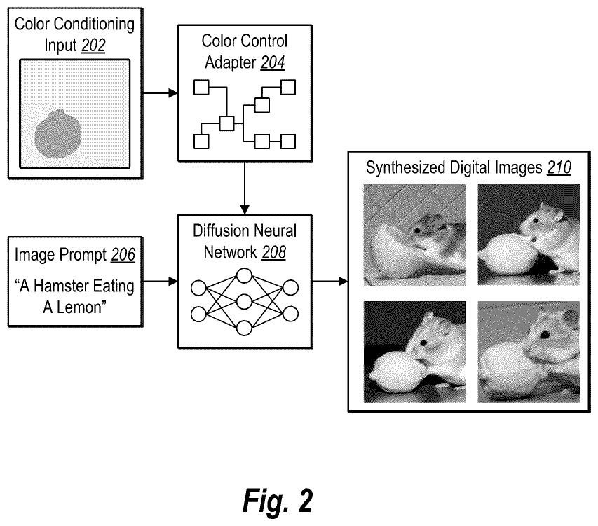

As mentioned, in one or more embodiments, the conditioned image generation system 106 generates a synthesized digital image from an image prompt and a color conditioning input. FIG. 2 illustrates an overview of generating a synthesized digital image from an image prompt and a color conditioning input in accordance with one or more embodiments. Additional detail regarding the various acts and processes mentioned with respect to FIG. 2 is provided thereafter with respect to subsequent figures.

As illustrated in FIG. 2, the conditioned image generation system 106 receives a color conditioning input 202 from a client device (e.g., the client device 114). In particular, the conditioned image generation system 106 receives the color conditioning input 202 that includes a colored region defining visual attributes (e.g., colors and positions) for conditioning a generative model, such as a diffusion neural network 208. Indeed, in some cases, the conditioned image generation system 106 receives the color conditioning input 202 as a colored region of pixels indicating a precise color and placement of an object to generate in an output image. In certain embodiments, the conditioned image generation system 106 receives or accesses the color conditioning input 202 in the form of an initial digital design or a template image selected (e.g., form a repository of template images) or generated via the client device.

As further illustrated in FIG. 2, the conditioned image generation system 106 processes the color conditioning input 202 through a color control adapter 204. In particular, the conditioned image generation system 106 inputs the color conditioning input 202 into the color control adapter 204, which uses the color conditioning input 202 to condition parameters of the diffusion neural network 208. In some embodiments, the color control adapter 204 utilizes or is made up of a neural network architecture (e.g., one or more convolutional layers) that process the color conditioning input 202 to inject color data and/or location data into various layers the diffusion neural network 208. In certain embodiments, the color control adapter 204 converts color data and/or location data into (partial or complete) latent vector embeddings for injection at one or more layers of the diffusion neural network 208. In some cases, the color control adapter 204 includes or is based on an architecture to control and guide the diffusion neural network 208.

As further illustrated in FIG. 2, the conditioned image generation system 106 receives an image prompt 206 from a client device (e.g., the client device 114). In particular, the conditioned image generation system 106 receives the image prompt 206 that includes a textual description defining visual attributes and/or generic concepts of a digital image (e.g., colors, positions, and background scenery). In some embodiments, the conditioned image generation system 106 receives the image prompt 206 in the form of a natural language description of digital content for a digital design. As shown, the image prompt 206 is a natural language description prompting the diffusion neural network 208 to generate images of a hamster eating a lemon.

As illustrated in FIG. 2, the conditioned image generation system 106 utilizes a diffusion neural network 208 to generate the synthesized digital images 210 from the color conditioning input 202 and the image prompt 206. As noted, the conditioned image generation system 106 passes the color conditioning input 202 through the color control adapter 204 to the diffusion neural network 208 and also passes the image prompt 206 into the diffusion neural network 208. In turn, the diffusion neural network 208 generates the synthesized digital images 210 that each depict a hamster eating a lemon, where the lemon is colored and placed according to the color conditioning input 202. Indeed, as shown the colored region of pixels in the color conditioning input 202 is a yellow color placed in a region corresponding to where the lemon is located in the synthesized digital images 210.

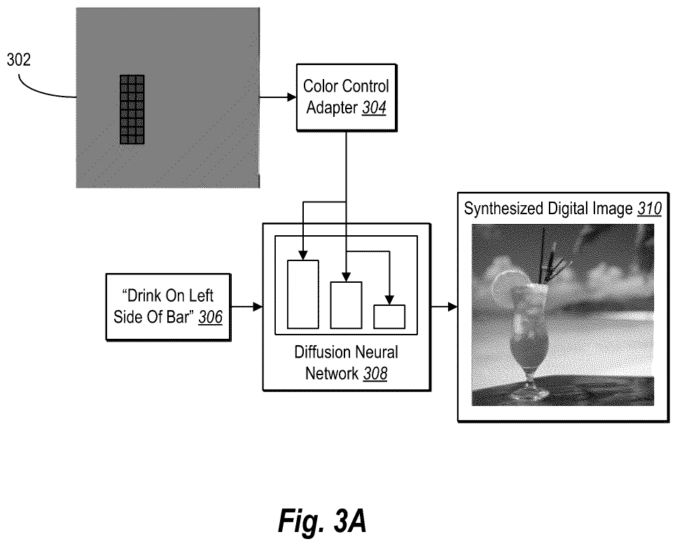

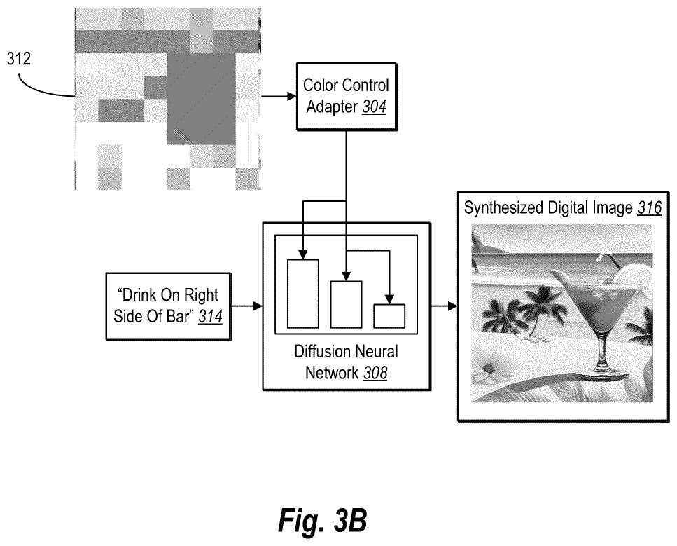

As mentioned above, in certain described embodiments, the conditioned image generation system 106 generates synthesized digital images that match the color and position of pixels in a color conditioning input. In particular, the conditioned image generation system 106 utilizes a combination of a color conditioning input and an image prompt to generate synthesized digital images, where the image prompt defines image content and the color conditioning input specifies the location and color of one or more objects. FIGS. 3A-3B illustrate example diagrams of generating synthesized digital images correlating with a color conditioning input and an image prompt in accordance with one or more embodiments. Specifically, FIG. 3A illustrates an example diagram for generating synthesized digital images from a color conditioning input that defines colored pixels (or super-pixels) to keep or follow in the generative diffusion process. FIG. 3B illustrates an example diagram for generating synthesized digital images from a color conditioning input that defines gray (or otherwise non-colored) pixels to remove, ignore, or omit in the generative diffusion process (and that further defines background color pixels to follow).

As illustrated in FIG. 3A, the conditioned image generation system 106 receives a color conditioning input 302 comprising a set of colored pixels at a pixel coordinate location. Further, in certain embodiments, the color conditioning input 302 is defined or set by an input from a client device. For instance, the color conditioning input 302 is create-able using few device interactions (e.g., fewer than a threshold number) and can thus be done quickly, such as by roughly coloring a set of pixels (or super-pixels) on a blank (or gray) background canvas. In some embodiments, the color conditioning input 302 comprises an input from a client device defining the location and color of a given digital image element.

As further illustrated in FIG. 3A, the conditioned image generation system 106 processes the color conditioning input 302 through a color control adapter 304. In particular, in some embodiments, the color control adapter 304 processes the color conditioning input 302 to augment or modify how layers of the diffusion neural network 308 process the image prompt 306. In certain embodiments, the color control adapter 304 extracts latent embeddings for color and/or location data from the color conditioning input 302 and injects the latent embeddings into a set of encoder layers in the diffusion neural network 308. In these or other embodiments, the color control adapter 304 modifies parameters of the diffusion neural network 308 and/or utilizes the latent embeddings to modify how the diffusion neural network 308 processes data.

As further illustrated in FIG. 3A, the conditioned image generation system 106 receives an image prompt 306. The conditioned image generation system 106 utilizes the diffusion neural network 308 to process both the image prompt 306 and the color conditioning input 302 processed by the color control adapter 304 (e.g., the latent color and position embeddings) to generate the synthesized digital image 310. In particular, the diffusion neural network 308 generates a synthesized digital image 310 depicting elements that match the color and location input from the color conditioning input 302 (an element matching the color and location of the pixels in the bottom left corner of the color conditioning input 302) and the image prompt 306 (a drink on the left side of a bar having dimensions corresponding to dimensions of the colored region in the color conditioning input 302).

As illustrated in FIG. 3B, the conditioned image generation system 106 receives a color conditioning input 312 depicting a set of non-colored (e.g., blank or gray) pixels contrasting with a colored region of pixels. Further, in certain embodiments, the conditioned image generation system 106 generates the color conditioning input 302 based on an input from a client device. In some embodiments, the conditioned image generation system 106 generates the color conditioning input 302 using fewer than a threshold number of device interactions (e.g., 5 or 10 interactions). In some embodiments, the conditioned image generation system 106 generates the color conditioning input 302 according to an input from a client device defining the location of a given digital image element and the color of the rest of the digital image surrounding the given digital image element.

As further illustrated in FIG. 3B, the conditioned image generation system 106 processes the color conditioning input 312 through the color control adapter 304. In particular, in some embodiments, the color control adapter 304 extracts latent embeddings for color and/or location data from the color conditioning input 312 and injects the latent embeddings into a set of transformer layers in the diffusion neural network 308.

As further illustrated in FIG. 3B, the conditioned image generation system 106 receives an image prompt 314. The conditioned image generation system 106 utilizes the diffusion neural network 308 to process both the image prompt 314 and the color conditioning input 312 processed by the color control adapter 304 (e.g., the latent color and position embeddings) to generate the synthesized digital image 316. In particular, the diffusion neural network 308 generates a synthesized digital image 316 depicting elements that match the color and location input from the color conditioning input 312 (e.g., an object synthesized to match the positioning of the blank/gray pixels of the color conditioning input 312 and background pixels matching the color values of the background pixels in the color conditioning input 312). The conditioned image generation system 106 further generates the synthesized digital image 316 according to the image prompt 314 by generating pixels depicting a drink on the right side of a bar having dimensions corresponding to dimensions of the non-colored region in the color conditioning input 312 and depicting background pixels colored according to the colors of the color conditioning input 312.

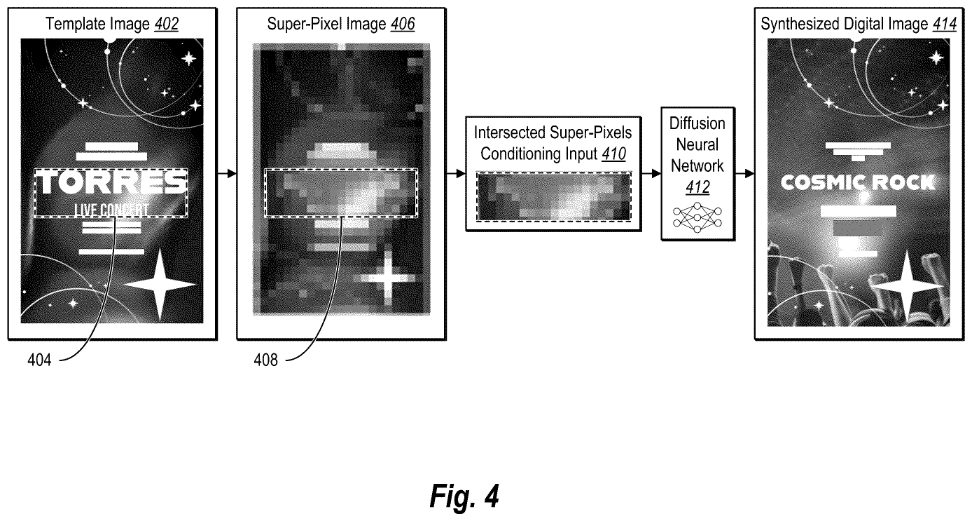

As noted above, in certain embodiments, the conditioned image generation system 106 receives a template image as a color conditioning input. In particular, the conditioned image generation system 106 utilizes this type of color conditioning input to generate a synthesized digital image matching the colors of the template image. FIG. 4 illustrates an example diagram for utilizing a colored template image to generate a correlating synthesized digital image in accordance with one or more embodiments.

As illustrated in FIG. 4, the conditioned image generation system 106 receives a template image 402. In some embodiments, the conditioned image generation system 106 receives the template image 402 from a client device as a colored design that contains both background pixels (e.g., depicting colors, shapes, and style) and one or more text regions, such as the text region 404 (e.g., defined by text box dimensions and a location). Further, in some embodiments, the conditioned image generation system 106 determines an intersection of the text region 404 (and other text regions) with background pixels of the template image 402. For instance, the conditioned image generation system 106 determines an area or a region of background pixels underlying a text region in the template image 402. In some cases, the conditioned image generation system 106 converts the background pixels to super-pixels. In one or more embodiments, the conditioned image generation system 106 keeps only the super-pixels intersected by the text region 404 as a conditioning input (discarding or ignoring non-intersected super-pixels). Accordingly, the conditioned image generation system 106 conditions a diffusion neural network 412 on colors underlying the text region 404, as indicated by the intersected super-pixels.

As just mentioned, and as further illustrated in FIG. 4, the conditioned image generation system 106 generates a super-pixel image 406 from the template image 402. In some embodiments, the conditioned image generation system 106 generates the super-pixel image 406 by modifying the template image 402 (or the intersected pixels of the text region 404) through a super-pixel generation process. As part of this process, the conditioned image generation system 106 downsamples the template image 402, or the intersected background pixels of the text region 404, (e.g., using bi-cubic downsampling) to generate super-pixels from pixels of the template image 402. Indeed, the conditioned image generation system 106 downsamples to generate super-pixels reflecting prominent colors in pixel groups (of particular dimensions and/or at particular intervals) throughout the template image 402, generating a super-pixel image 406. By preserving the defined intersection of the text region 404 with the template image 402, the conditioned image generation system 106 further generates a region of intersected super-pixels 408 representing the super-pixel image 406.

As further illustrated in FIG. 4, the conditioned image generation system 106 processes the super-pixel image 406 (e.g., the intersected super-pixels 408) to generate an intersected super-pixels conditioning input 410. In some embodiments, the conditioned image generation system 106 uses the intersected super-pixels conditioning input 410 to condition a diffusion neural network 412. In some embodiments, the conditioned image generation system 106 utilizes the diffusion neural network 412, conditioned on the intersected super-pixels conditioning input 410, to generate a synthesized digital image 414. As shown, the synthesized digital image 414 correlates or reflects colors with the background appearance (e.g., colors and style) of the text region 404 within the template image 402.

In some embodiments, the conditioned image generation system 106 adds additional elements to the synthesized digital image 414, such as text elements, shapes, and/or objects that appear in the template image 402. Further, in some embodiments, the conditioned image generation system 106 generates the synthesized digital image 414 to include text that differs from that of the template image 402 but with a similar style and placement.

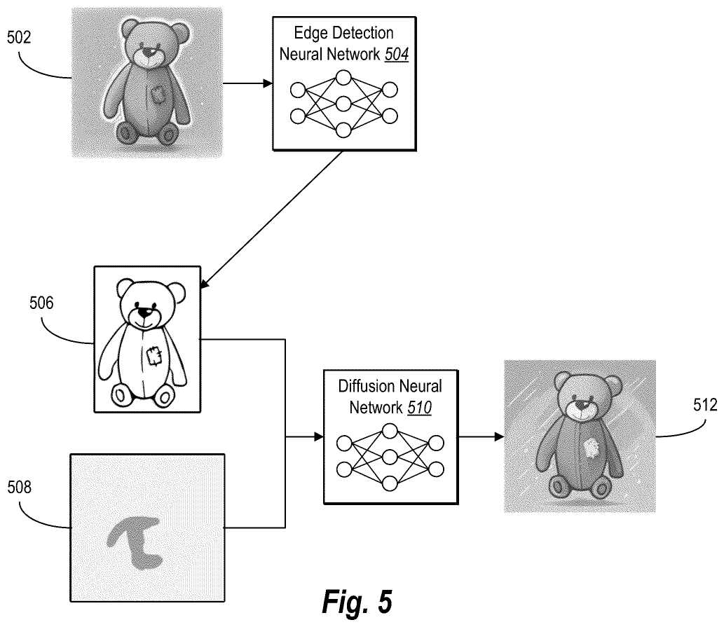

As noted above, in some embodiments, the conditioned image generation system 106 generates a synthesized digital image based on a color conditioning input together with one or more supplementary conditional inputs. In particular, the conditioned image generation system 106 utilizes detected edges as supplemental conditioning with a color conditioning input. FIG. 5 illustrates an example diagram for generating a synthesized digital images based on a color conditioning input and detected edges in accordance with one or more embodiments.

As illustrated in FIG. 5, the conditioned image generation system 106 receives an image 502. In some embodiments, the image 502 depicts an object, such as a geometric shape, a car, a person, a building, or piece of fruit. As shown, the image 502 depicts a teddy bear.

As further illustrated in FIG. 5, the conditioned image generation system 106 utilizes the image 502 as the basis for generating supplemental conditioning input. Indeed, the conditioned image generation system 106 utilizes an edge detection neural network 504 to detect edges depicted in the image 502. The edge detection neural network 504, in some embodiments, refers to a neural network trained to detect, extract, or segment edges of a given input image (e.g., the image 502). In certain embodiments, the edge detection neural network 504 includes various neural network model architectures, such as convolutional layers and activation functions to produce an edge map highlighting the boundaries of objects, with optional pooling and additional convolutional layers for refining feature extraction and post-processing to enhance edge details. The conditioned image generation system 106 thus generates or extracts an edge conditioning input 506 using the edge detection neural network 504.

As further illustrated in FIG. 5, the conditioned image generation system 106 inputs the edge conditioning input 506 and a color conditioning input 508 into a diffusion neural network 510. In certain embodiments, the conditioned image generation system 106 trains the diffusion neural network 510 to respect edges (and color conditions) of a given input image (e.g., the edge conditioning input 506).

As further illustrated in FIG. 5, the conditioned image generation system 106, using the diffusion neural network 510, generates a synthesized digital image 512. In some embodiments, the synthesized digital image 512 depicts an object adhering to the edges in the edge conditioning input 506 while also following colors and locations indicated by pixels in the color conditioning input 508. In certain embodiments, the conditioned image generation system 106 generates a synthesized digital image 512 with only the edge conditioning input 506 as conditioning, generating a synthesized digital image that adheres to the edges in the edge conditioning input 506 and with an unspecified color. In some embodiments, the conditioned image generation system 106 generates a synthesized digital image 512 with only the color conditioning input 508 as conditioning, generating a synthesized digital image that adheres to the color specified in the color conditioning input 508 and with an unspecified shape. Further, in certain embodiments, the conditioned image generation system 106 generates the synthesized digital image 512 using the diffusion neural network conditioned on at one of, both of, or either of the color conditioning input 508 and/or the edge conditioning input 506 along with an image prompt (e.g., “generate a blue teddy bear”). Further, in one or more embodiments, the conditioned image generation system 106 generates the synthesized digital image without either the color conditioning input 508 or the edge conditioning input 506 (e.g., generating the image solely based on an image prompt to “generate a blue teddy bear”).

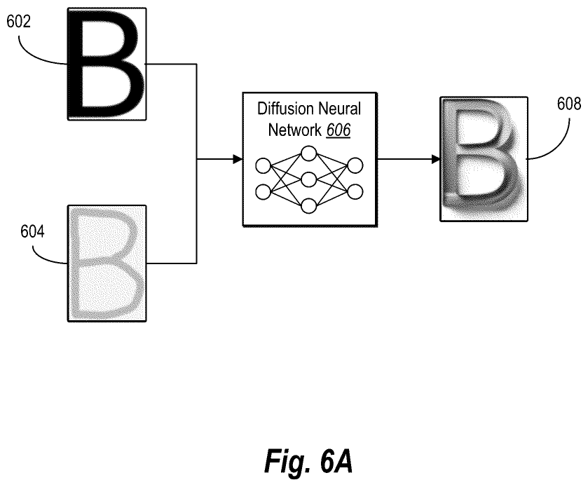

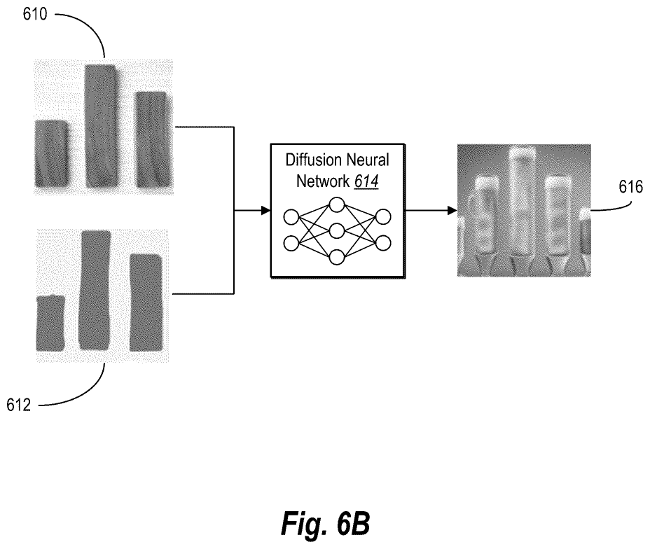

As noted above, in certain embodiments, the conditioned image generation system 106 generates design elements (e.g., text effects or chart effects). In particular, the conditioned image generation system 106 generates synthesized digital images in the form of text characters or graphical charts using color conditioning inputs along with respective supplemental conditioning inputs. FIGS. 6A-6B illustrate example diagrams for generating design elements using color conditioning and supplemental conditioning to generate text effects and chart effects using color conditioning and text edge conditioning. In particular, FIG. 6A illustrates an example diagram for generating a text effect in accordance with a given template text effect. FIG. 6B illustrates an example diagram for generating a chart effect using color conditioning and chart edge conditioning.

As illustrated in FIG. 6A, the conditioned image generation system 106 receives a template text effect 602. In some embodiments, the template text effect 602 depicts an alphabetic character depicted in a certain style. In certain embodiments, the template text effect 602 depicts an alphabetic character corresponding to a certain font (e.g., Times New Roman, Arial, Papyrus) or a certain design style, such as bold, underlined, italics, and/or in a particular color. In some cases, the conditioned image generation system 106 pads white pixels around edges of the glyph depicted in the template text effect 602 to keep a small buffer and avoid cutouts.

As further illustrated in FIG. 6A, the conditioned image generation system 106 receives a color conditioning input 604. In some embodiments, the color conditioning input 604 depicts a color value that is input by a client device. In some embodiments, the color conditioning input 604 is creatable from few device inputs, such as an irregularly shaped and sized group of pixels using few device interactions (e.g., fewer than a threshold number) and can thus be done quickly, such as by roughly coloring a set of pixels (or super-pixels) on a blank (or gray) background canvas. In some embodiments, the color conditioning input 604 is creatable from an alphanumeric input (e.g., a letter corresponding to a certain font submitted by a client device).

As further illustrated in FIG. 6A, the conditioned image generation system 106 utilizes the template text effect 602 and/or the color conditioning input 604 to condition a diffusion neural network 606. In some embodiments, the conditioned image generation system 106 modifies the template text effect 602 by padding the edges with a white buffer before conditioning the diffusion neural network 606. In some embodiments, the diffusion neural network 606 includes neural network architecture trained to respect edges of a given input image (e.g., the template text effect 602). In some embodiments, the diffusion neural network 606 includes various neural network model architectures implementing methods for adhering to edges of a given input image.

As further illustrated in FIG. 6A, the conditioned image generation system 106 utilizes the diffusion neural network 606 conditioned by the template text effect 602 and the color conditioning input 604 to generate a synthesized text effect 608, with the synthesized text effect 608 correlating with the style of the template text effect 602 and the color of the color conditioning input 604. In some embodiments, the synthesized text effect 608 depicts an alphabetic character matching the certain design style or the certain font (e.g., Times New Roman, Arial, or Papyrus) of the template text effect 602.

As illustrated in FIG. 6B, the conditioned image generation system 106 receives a template chart effect 610. In certain embodiments, the template chart effect 610 depicts a graphical representation of data (e.g., a bar graph). In further embodiments, the template chart effect 610 depicts a graphical representation of data with a given shape and design. In some cases, the conditioned image generation system 106 pads white pixels around edges of the chart depicted in the template chart effect 610 to keep a small buffer and avoid cutouts.

As further illustrated in FIG. 6B, the conditioned image generation system 106 receives a color conditioning input 612. In some embodiments, the color conditioning input 612 depicts a color value input by a client device. In some embodiments, the color conditioning input 612 is creatable from few device inputs, such as an irregularly shaped and sized group of pixels using few device interactions (e.g., fewer than a threshold number) and can thus be done quickly, such as by roughly coloring a set of pixels (or super-pixels) on a blank (or gray) background canvas. In some embodiments, the color conditioning input 612 is creatable from a chart input (e.g., a sample chart submitted by a client device).

As further illustrated in FIG. 6B, the conditioned image generation system 106 utilizes the template chart effect 610 and/or the color conditioning input 612 to condition a diffusion neural network 614. In some embodiments, the conditioned image generation system 106 modifies the template chart effect 610 by padding the edges of the template chart effect 610 with a white buffer. In some embodiments, the diffusion neural network 614 utilizes a neural network architecture that is not trained to strictly adhere to the edges of the template chart effect 610. Thus, the conditioned image generation system 106 utilizes a diffusion neural network to generate chart effects without constraining the network parameters on edges, thereby enabling the diffusion neural network to generate images with chart effects that extend beyond the limits of the chart edges.

As further illustrated in FIG. 6B, the conditioned image generation system 106 utilizes the diffusion neural network 614 conditioned by the template chart effect 610 and the color conditioning input 612 to generate a synthesized chart effect 616, with the synthesized chart effect 616 correlating with the shape of the template chart effect 610 and the color of the color conditioning input 612. In some embodiments, the outline of the shape of the synthesized chart effect 616 does not exactly match the shape of the template chart effect 610 (e.g., the shape of the synthesized chart effect 616 being that of cylindrical beer glasses with the shape of the template chart effect 610 being rectangles). Further, in certain embodiments, the conditioned image generation system 106 generates the synthesized chart effect 616 using the diffusion neural network 614 conditioned on the template chart effect 610 and the color conditioning input 612 along with an image prompt (e.g., “generate a bar graph wherein the bars are beer glasses”).

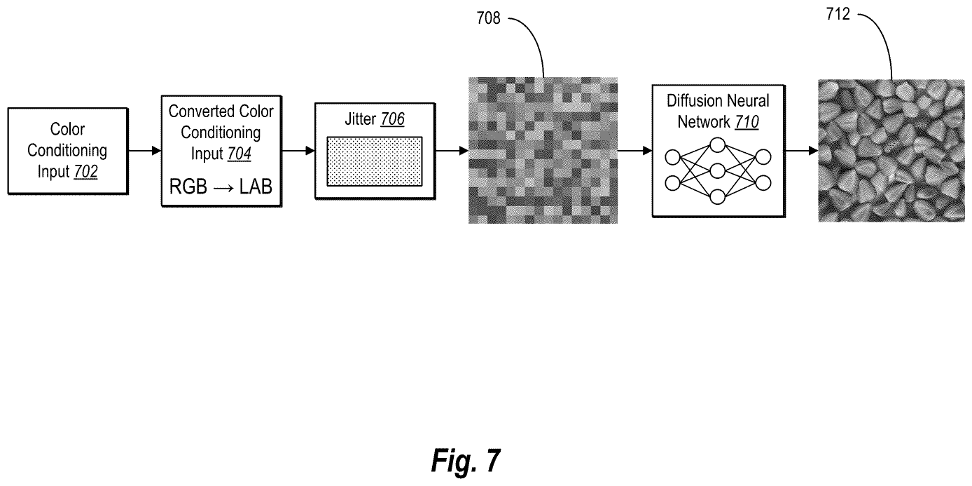

As noted above, in certain embodiments, the conditioned image generation system 106 generates textured digital images. In particular, the conditioned image generation system 106 modifies a color conditioning input by inputting jitter to simulate textures and utilizes this modified color conditioning input to generate textured digital images. FIG. 7 illustrates an example diagram of generating a textured digital image in accordance with one or more embodiments.

As illustrated in FIG. 7, the conditioned image generation system 106 receives a color conditioning input 702. In some embodiments, the color conditioning input 702 is an image of pixels or super-pixels depicting a single color value. In certain embodiments, the color conditioning input 702 depicts an image of a given size or resolution filled with the single color value.

As further illustrated in FIG. 7, the conditioned image generation system 106 modifies the color conditioning input 702 to generate a converted color conditioning input 704. In some embodiments, the conditioned image generation system 106 modifies the color conditioning input 702 by converting the color value of the color conditioning input 702 from one color space to another. For instance, the conditioned image generation system 106 converts the color conditioning input 702 from a Red Green Blue (RGB) value to an LAB (luminance) value.

An LAB (luminance) value represents the lightness of a color, representing color with L (luminance), A (green-red color axis), and B (blue-yellow color axis). In some embodiments, luminance includes or refers to a value relating to the lightness, intensity or brightness of a given pixel. In particular, luminance refers to a value representing the brightness of the pixel, ranging from 0 (black) to 100 (white) (without considering chromatic information). To illustrate, a luminance parameter indicates how dark or how light the color of a given pixel appears.

In some embodiments, luminance includes or refers to a value relating to the, lightness, intensity, or brightness of a given pixel. In particular, luminance refers to a value representing the brightness of the pixel, ranging from black to white (without considering chromatic information). To illustrate, a luminance parameter indicates how dark or how light the color of a given pixel appears.

As further illustrated in FIG. 7, the conditioned image generation system 106 inserts or injects jitter 706 into the converted color conditioning input 704. In some embodiments, the conditioned image generation system 106 inserts jitter 706 by increasing or decreasing the luminance value of various pixels or super-pixels in the converted color conditioning input 704 within a given range. In certain embodiments, the conditioned image generation system 106 sets a minimum/maximum value for luminance and then increases or decreases the luminance value of each pixel in the converted color conditioning input 704 up to the minimum/maximum value for luminance.

In some embodiments, jitter refers to a random variation to a given parameter. For instance, the conditioned image generation system 106 generates a jitter map for luminance, indicating random changes to luminance values across pixel (or super-pixel) coordinates of the converted color conditioning input 704. To illustrate, the conditioned image generation system 106 applies the jitter map to make random variations in the luminance value (within a given range) to increase variability in the luminance across the image as a whole.

As further illustrated in FIG. 7, the conditioned image generation system 106 utilizes the jitter 706 to generate a jitter modified color conditioning input 708. In some embodiments, the jitter modified color conditioning input 708 depicts a non-uniform color conditioning input due to the jitter modified luminance parameters. In certain embodiments, the conditioned image generation system 106 converts the jitter modified color conditioning input 708 from an LAB value to an RGB value.

As further illustrated in FIG. 7, the conditioned image generation system 106 feeds the jitter modified color conditioning input 708 into a diffusion neural network 710. Accordingly, the conditioned image generation system 106 utilizes the diffusion neural network 710 (conditioned on the jitter modified color conditioning input 708) to generate a textured synthesized digital image 712. In some embodiments, the textured synthesized digital image 712 simulates the appearance of a textured surface (e.g., a bowl of cut strawberries). Indeed, depending on an input prompt, the conditioned image generation system 106 generates texture images depicting a variety of content.

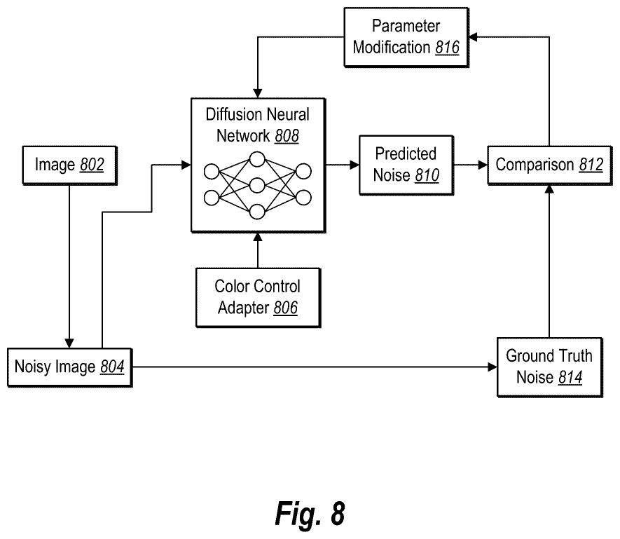

As noted above, in certain embodiments, the conditioned image generation system 106 trains a diffusion neural network to generate synthesized digital images while conditioned on color conditioning inputs. In particular, the conditioned image generation system 106 performs a process of adding noise to images and comparing the predicted noise generated by the diffusion neural network with the actual noise added. FIG. 8 illustrates an example diagram for training a diffusion neural network in accordance with one or more embodiments.

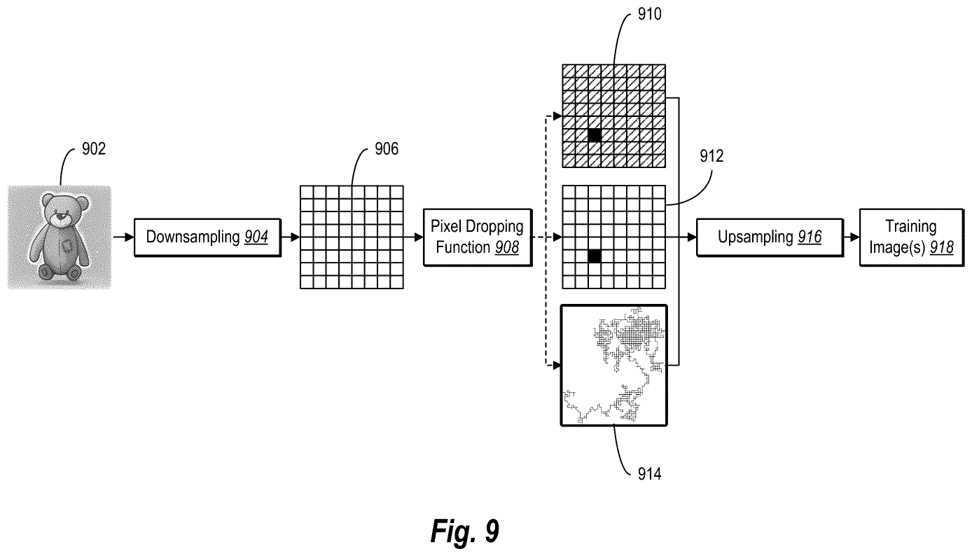

As illustrated in FIG. 8, the conditioned image generation system 106 utilizes an image 802. In some embodiments, the image 802 is an image from a digital library. In certain embodiments, the conditioned image generation system 106 generates the image 802 to train the diffusion neural network 808 on how to generate synthesized digital images conditioned on color conditioning input. Further information on these embodiments is illustrated in FIG. 9.

As further illustrated in FIG. 8, the conditioned image generation system 106 uses the image 802 to generate a noisy image 804. In some embodiments, the conditioned image generation system 106 generates the noisy image 804 by introducing random variations in pixel values in the image 802, making the noisy image 804 appear scattered or grainy.

As further illustrated in FIG. 8, the conditioned image generation system 106 generates a ground truth noise 814 to serve as a reference for training the diffusion neural network 808. In some embodiments, the conditioned image generation system 106 generates the ground truth noise 814 as the actual noise vector added to generate the noisy image 804 from the image 802.

As further illustrated in FIG. 8, the conditioned image generation system 106 uses a color control adapter 806 to condition the diffusion neural network 808. In some embodiments, the color control adapter 806 utilizes or is made up of a neural network architecture (e.g., one or more convolutional layers) that process color conditioning input to condition the diffusion neural network 808 by injecting color data and/or location data into various layers of the diffusion neural network 808. In one or more embodiments, the color control adapter 806 conditions the diffusion neural network 808 by injecting modified super-pixel images (more information on the generation of these modified super-pixel images is given in FIG. 9) as color data and/or location data for conditioning the diffusion neural network 808. In certain embodiments, the color control adapter 806 converts color data and/or location data into (partial or complete) latent vector embeddings for injection at one or more layers of the diffusion neural network 808. In some cases, the color control adapter 806 includes or is based on an architecture to control and guide the diffusion neural network 808.

As further illustrated in FIG. 8, the conditioned image generation system 106 trains a diffusion neural network 808. In some embodiments, the conditioned image generation system 106 utilizes the diffusion neural network 808 to generate, based on the color control adapter 806, a predicted noise 810 for the noisy image 804. In certain embodiments, the conditioned image generation system 106 uses the diffusion neural network 808 to estimate or predict the noise added to the image 802, generating the predicted noise 810.

As further illustrated in FIG. 8, the conditioned image generation system 106 performs a comparison 812 between the predicted noise 810 and the ground truth noise 814. In some embodiments, the conditioned image generation system 106 performs the comparison 812 to determine a difference or a loss between the predicted noise 810 and the ground truth noise 814. In certain embodiments, the conditioned image generation system 106 uses a loss function (e.g., mean squared error) in the comparison 812 to calculate the difference between the predicted noise 810 and the ground truth noise 814.

As further illustrated in FIG. 8, the conditioned image generation system 106 uses the comparison 812 to perform a parameter modification 816 to modify the diffusion neural network 808. In some embodiments, the conditioned image generation system 106 uses the calculated loss in the comparison 812 to inform the parameter modification 816. In certain embodiments, the conditioned image generation system 106 uses the parameter modification 816 to adjust the parameters of the diffusion neural network 808 to improve the ability of the diffusion neural network 808 to generate the predicted noise 810. Further, in one or more embodiments, the conditioned image generation system 106 uses an optimization algorithm (e.g., gradient descent) as part of the parameter modification 816.

As noted above, in certain embodiments, the conditioned image generation system 106 generates a library of training images for training a diffusion neural network (e.g., to use as the image 802). In particular, the conditioned image generation system 106 generates super-pixel images and then employs a variety of pixel dropping functions to generate a library of training images. FIG. 9 illustrates an example diagram for generating a library of training images in accordance with one or more embodiments.

As illustrated in FIG. 9, the conditioned image generation system 106 receives an image 902. The conditioned image generation system 106 performs a downsampling 904 on the image 902. In some embodiments, the conditioned image generation system 106 performs the downsampling 904 by decreasing the number of pixels of the image 902. For instance, the conditioned image generation system 106 overlays a grid of super-pixel dimensions, averaging pixel values in each of the grid locations to determine the super-pixel values. In certain embodiments, the conditioned image generation system 106 performs the downsampling 904 through a downsampling method (e.g., bi-cubic downsampling, averaging neighboring pixel values, or subsampling neighboring pixel values).

As further illustrated in FIG. 9, the conditioned image generation system 106 performs the downsampling 904 on the image 902 to generate a super-pixel image 906. In some embodiments, the conditioned image generation system 106 generates a super-pixel image 906 as a grid that preserves the genericity of the color information of the image 902.

As further illustrated in FIG. 9, the conditioned image generation system 106 performs a pixel dropping function 908 on the super-pixel image 906. In some embodiments, the pixel dropping function 908 drops pixels by setting the color value of a given super-pixel to a specific color (e.g., gray with the RGB color value of 127, 127, 127). In one or more embodiments, the pixel dropping function 908 drops pixels by setting the alpha value of a given super-pixel to 0.

In one or more embodiments, an alpha value refers to a component of a color model representing the transparency of a color. In particular, the alpha value refers to a value that represents the transparency of a color as applied to individual pixels. To illustrate, an alpha value can be applied to any pixel to determine the transparency of the given color value applied to the pixel. The conditioned image generation system 106 utilizes the alpha value to emphasize or de-emphasize pixels or super-pixels of an image, which provides a strong signal to a diffusion neural network ignore the corresponding pixels or super-pixels. Indeed, using an alpha value of 0 often encourages the diffusion neural network to ignore (or not condition on) such regions of pixels or super-pixels during training.

As further illustrated in FIG. 9, the conditioned image generation system 106 uses the pixel dropping function 908 to generate three types of pixel dropped images. For instance, in some embodiments, the conditioned image generation system 106 generates a super-pixel dropped image 910, a super-pixel kept image 912, and/or a random walk image 914, each for a respective training modality. In one or more embodiments, the conditioned image generation system 106 uses the pixel dropping function 908 to randomly generate either the super-pixel dropped image 910, the super-pixel kept image 912, or the random walk image 914.

As further illustrated in FIG. 9, in one or more embodiments, the conditioned image generation system 106 uses the pixel dropping function 908 to generate the super-pixel dropped image 910. For example, the conditioned image generation system 106 utilizes the pixel dropping function 908 to select a size and position for a shape enclosing a set of super-pixels within the super-pixel image 906. Further, in some embodiments, the conditioned image generation system 106 selects a size and position for a shape by randomly selects a rectangle such that each dimension of the rectangle is smaller than three-quarters (or some other threshold proportion) of the dimensions of the super-pixel image 906 with the top left position of the rectangle fit inside the super-pixel image 906. The conditioned image generation system 106 further drops the set of super-pixels enclosed by the shape to generate the super-pixel dropped image 910.

As further illustrated in FIG. 9, in one or more embodiments, the conditioned image generation system 106 uses the pixel dropping function 908 to generate a super-pixel kept image 912. In one or more embodiments, the conditioned image generation system 106 utilizes the pixel dropping function 908 to select a size and position for a shape enclosing a set of super-pixels within the super-pixel image 906. Further, in some embodiments, the conditioned image generation system 106 selects a size and position for a shape by randomly selects a rectangle such that each dimension of the rectangle is smaller than three-quarters (or some other threshold proportion) of the dimensions of the super-pixel image 906 with the top left position of the rectangle fit inside the super-pixel image 906. The conditioned image generation system 106 further drops the set of super-pixels outside of the shape to generate the super-pixel kept image 912.

As further illustrated in FIG. 9, in one or more embodiments, the conditioned image generation system 106 uses the pixel dropping function 908 to generate a random walk image 914. In one or more embodiments, the conditioned image generation system 106 utilizes the pixel dropping function 908 to create a random walk in the super-pixel image 906 and drops pixels selected by the random walk. In some embodiments, the conditioned image generation system 106 creates the random walk by starting from a random position in the super-pixel image 906 and then performing a random walk for a random number of pixels less than a quarter (or some other threshold proportion) of the total number of pixels in the super-pixel image 906, with the random walk not selecting the same pixel to be dropped twice.

In certain embodiments, a random walk refers to a mathematical concept that describes a path with each step of the path determined by a random process. In particular, a random walk takes a step along pixels randomly, without any specific direction or pattern. To illustrate, a random walk starts at a specific point and then steps along a path, with each step being made randomly without any specific direction or pattern with the direction and magnitude determined by a probability distribution.

As further illustrated in FIG. 9, the conditioned image generation system 106 performs an upsampling 916 on the super-pixel images (e.g., 910, 912, and 914) generated by the pixel dropping function 908. In one or more embodiments, the conditioned image generation system 106 performs the upsampling 916 by increasing the resolution of the super-pixel images (e.g., 910, 912, and 914) by increasing the pixel count, which makes each pixel smaller so as to show finer detail. In specific, in certain embodiments, the conditioned image generation system 106 performs the upsampling 916 by adding new pixels between the pixels in the super-pixel images (e.g., 910, 912, and 914) using an upsampling process such as nearest neighbor interpolation or bicubic interpolation.

As further illustrated in FIG. 9, the conditioned image generation system 106 performs the upsampling 916 to generate training image(s) 918. In some embodiments, the conditioned image generation system 106 uses the training image(s) 918 as conditioning to train a diffusion neural network. In certain embodiments, the conditioned image generation system 106 uses the training image(s) 918 to train a diffusion neural network to generate synthesized digital images in accordance with color conditioning inputs.

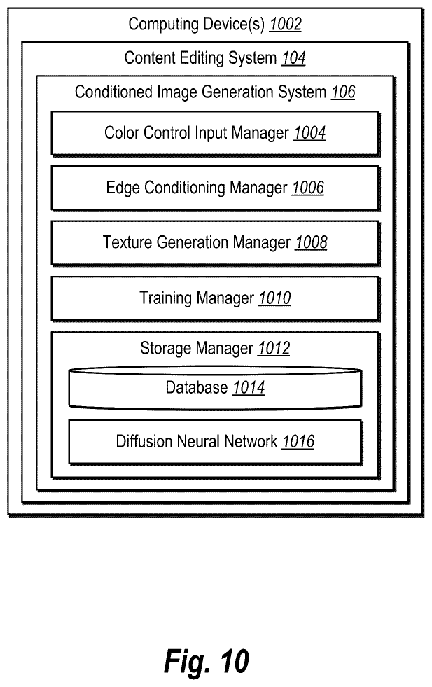

Referring now to FIG. 10, additional detail will be provided regarding components and capabilities of the conditioned image generation system 106. Specifically, FIG. 10 illustrates an example schematic diagram of the conditioned image generation system 106 on an example computing device(s) 1002 (e.g., one or more of the client device 114 and/or the server device(s) 102). As shown in FIG. 10, the conditioned image generation system 106 includes a color control input manager 1004, an edge conditioning manager 1006, a texture generation manager 1008, a training manager 1010, and a storage manager 1012.

As mentioned, the conditioned image generation system 106 includes a color control input manager 1004. In particular, the color control input manager 1004 receives, modifies, generates, alters, or augments a color conditioning input associated with generating a synthesized digital image. For example, the color control input manager 1004 receives a color conditioning input from a client device and converts the color conditioning input into a format usable to condition a diffusion neural network (e.g., the diffusion neural network 1016).

As mentioned, the conditioned image generation system 106 includes an edge conditioning manager 1006. In particular, the edge conditioning manager 1006 extracts edge conditioning of a color conditioning input to condition synthesized digital image generation by a diffusion neural network (e.g., the diffusion neural network 1016). For example, the edge conditioning manager 1006 receives a color conditioning input from a client device and extracts edge conditioning from the color conditioning input to condition the diffusion neural network.

As mentioned, the conditioned image generation system 106 includes a texture generation manager 1008. In particular, the texture generation manager 1008 generates texture in synthesized digital images by introducing jitter in the luminance value of a color conditioning input. For example, the texture generation manager 1008 receives a color conditioning input from a client device and introduces jitter in the luminance value to condition a diffusion neural network (e.g., the diffusion neural network 1016) to generate a textured synthesized digital image.

As mentioned, the conditioned image generation system 106 includes a training manager 1010. In particular, the training manager 1010 trains a diffusion neural network (e.g., the diffusion neural network 1016) to generate synthesized digital images. For example, the training manager 1010 generates a library of training images and trains the diffusion neural network to predict noise generation in images.

The conditioned image generation system 106 further includes a storage manager 1012. The storage manager 1012 operates in conjunction with the other components of the conditioned image generation system 106 and includes one or more memory devices such as the database 1014 (e.g., the database 110) that stores various data such as training images, digital images, and other information. In some cases, the storage manager 1012 also manages or maintains a diffusion neural network 1016 for generating synthesized digital images using one or more components of the conditioned image generation system 106 as described above.

In one or more embodiments, each of the components of the conditioned image generation system 106 are in communication with one another using any suitable communication technologies. Additionally, the components of the conditioned image generation system 106 are in communication with one or more other devices including one or more client devices described above. It will be recognized that although the components of the conditioned image generation system 106 are shown to be separate in FIG. 10, any of the subcomponents may be combined into fewer components, such as into a single component, or divided into more components as may serve a particular implementation. Furthermore, although the components of FIG. 10 are described in connection with the conditioned image generation system 106, at least some of the components for performing operations in conjunction with the conditioned image generation system 106 described herein may be implemented on other devices within the environment.

The components of the conditioned image generation system 106 include software, hardware, or both. For example, the components of the conditioned image generation system 106 include one or more instructions stored on a computer-readable storage medium and executable by processors of one or more computing devices (e.g., the computing device(s) 1002). When executed by the one or more processors, the computer-executable instructions of the conditioned image generation system 106 cause the computing device(s) 1002 to perform the methods described herein. Alternatively, the components of the conditioned image generation system 106 comprise hardware, such as a special purpose processing device to perform a certain function or group of functions. Additionally, or alternatively, the components of the conditioned image generation system 106 include a combination of computer-executable instructions and hardware.

Furthermore, the components of the conditioned image generation system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the conditioned image generation system 106 may be implemented as part of a stand-alone application on a personal computing device or a mobile device. Alternatively, or additionally, the components of the conditioned image generation system 106 may be implemented in any application that allows creation and delivery of content to users, including, but not limited to, applications in ADOBE® EXPERIENCE MANAGER and CREATIVE CLOUD®, such as PHOTOSHOP®, LIGHTROOM®, FIREFLY®, and INDESIGN®. “ADOBE,” “ADOBE EXPERIENCE MANAGER,” “CREATIVE CLOUD,” “PHOTOSHOP,” “LIGHTROOM,” “FIREFLY” and “INDESIGN” are either registered trademarks or trademarks of Adobe Inc. in the United States and/or other countries.

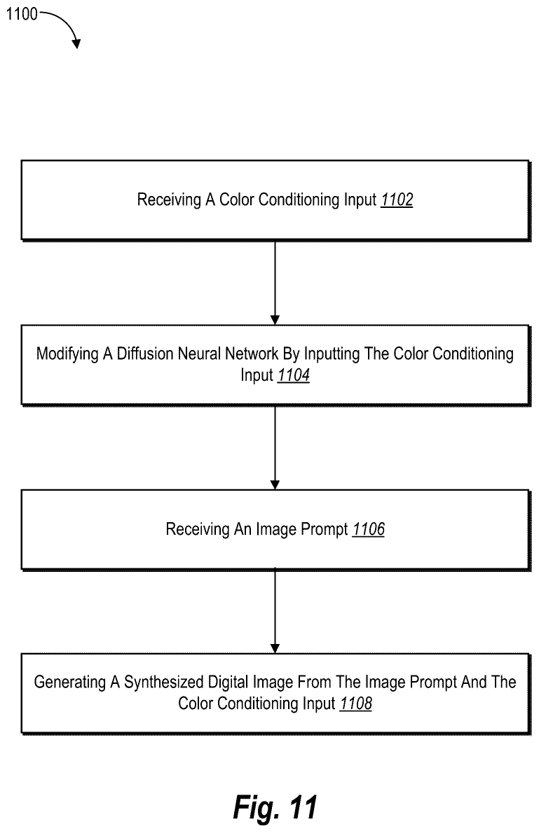

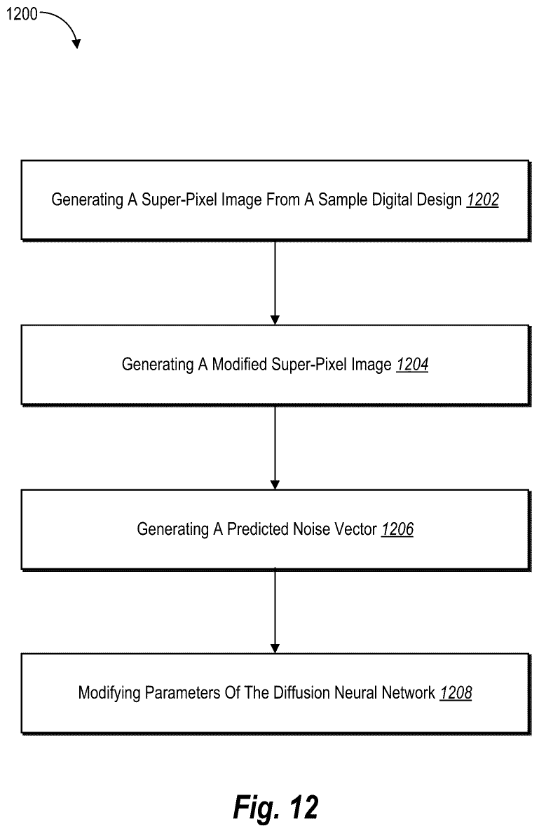

FIGS. 1-10, the corresponding text, and the examples provide a number of different systems, methods, and non-transitory computer readable media for generating a synthesized digital image using a diffusion neural network conditioned on an image prompt and a color conditioning input, so as to generate a synthesized digital image in conformity with the image prompt and the color conditioning prompt. In addition to the foregoing, embodiments can also be described in terms of flowcharts comprising acts for accomplishing a particular result. For example, FIGS. 11-12 illustrate flowcharts of example sequences or series of acts in accordance with one or more embodiments.

While FIGS. 11-12 illustrate acts according to particular embodiments, alternative embodiments may omit, add to, reorder, and/or modify any of the acts shown in FIGS. 11-12. The acts of FIGS. 11-12 can be performed as part of a method. Alternatively, a non-transitory computer readable medium can comprise instructions, that when executed by one or more processors, cause a computing device to perform the acts of FIGS. 11-12. In still further embodiments, a system can perform the acts of FIGS. 11-12. Additionally, the acts described herein may be repeated or performed in parallel with one another or in parallel with different instances of the same or other similar acts.

FIG. 11 illustrates an example series of acts 1100 for generating a synthesized digital image using a diffusion neural network modified by a color conditioning input and using an image prompt. In particular, the series of acts 1100 includes an act 1102 of receiving a color conditioning input. For example, the act 1102 involves receiving a region of colored pixels, a template image, or a text or chart effect. Further, the series of acts 1100 includes an act 1104 of modifying a diffusion neural network by inputting the color conditioning input. For example, the act 1104 involves utilizing the color conditioning input by inputting it as conditioning into a diffusion neural network. Further, the series of acts 1100 includes an act 1106 of receiving an image prompt. For example, the act 1106 involves receiving a textual description of an object and/or scenery of a synthesized digital image. Further, the series of acts 1100 includes an act 1108 of generating a synthesized digital image from the image prompt and the color conditioning input. For example, the act 1108 involves generating a synthesized digital image correlating with the image prompt and the color conditioning input by using the diffusion neural network conditioned on the color conditioning input.

In some embodiments, the series of acts 1100 includes receiving, from a client device, an image prompt comprising a text description of a digital image and a color conditioning input defining a position of a color value for the digital image; generating, utilizing a diffusion neural network to process the image prompt and the color conditioning input, a synthesized digital image depicting content corresponding to the text description and comprising pixels reflecting the color value at the position; and providing the synthesized digital image for display on the client device.

In some embodiments, the series of acts 1100 includes conditioning the diffusion neural network by processing the color conditioning input using a color control adapter, with the condition image depicting pixels in the color value at one or pixel coordinates defining the position.

In some embodiments, the series of acts 1100 includes receiving a condition image depicting: pixels depicting a gray color value at one or more pixel coordinates defining the position; and pixels depicting non-gray color values at pixel coordinates other than the one or more pixel coordinates defining the position.

In some embodiments, the series of acts 1100 includes detecting edges depicted in the digital image using an edge detection neural network; and conditioning synthesis of the diffusion neural network using the edges together with the color conditioning input.

In some embodiments, the series of acts 1100 includes receiving a condition image of a design template depicting the color value at the position and a text design element; generating a padded text effect, wherein generating the padded text effect comprises padding edges depicted in the text design element using an edge detection neural network; and conditioning synthesis of the diffusion neural network using the padded text effect together with the color conditioning input.

In some embodiments, the series of acts 1100 includes receiving, from a client device, an image prompt comprising a text description of a digital image and a color conditioning input defining a position of a color value for the digital image; modifying a diffusion neural network by injecting the color conditioning input into layers of the diffusion neural network using a color control adapter; generating, utilizing the diffusion neural network conditioned on the color conditioning input, a synthesized digital image depicting content corresponding to the text description and comprising pixels reflecting the color value at the position; and providing the synthesized digital image for display on the client device.

In some embodiments, the series of acts 1100 includes transforming, using the color control adapter, the color conditioning input according to a pixel dropping function by dropping, using the color control adapter, one or more super-pixels not depicting the color value within the color conditioning input according to a first pixel dropping function; or dropping, using the color control adapter, one or more super-pixels depicting the color value within the color conditioning input according to a second pixel dropping function.

In some embodiments, the series of acts 1100 includes receiving a template image with a text region and a color scheme; and generating the synthesized digital image by generating, using the diffusion neural network, synthesized pixels according to the color scheme and the text region of the template image adapted to the image prompt.

In some embodiments, the series of acts 1100 includes generating, from the template image, a super-pixel image reflecting the color scheme; determining intersected super-pixels within the super-pixel image that intersect the text region of the template image; and generating the synthesized digital image using the diffusion neural network conditioned on the intersected super-pixels.

In some embodiments, the series of acts 1100 includes converting the color conditioning input from a first color space to a second color space that defines a luminance parameter of the color conditioning input; and modifying the color conditioning input by injecting jitter into the luminance parameter, to generate a synthesized digital image utilizing the diffusion neural network conditioned on the modified color conditioning input.

FIG. 12 illustrates an example series of acts 1200 for training a diffusion neural network in accordance with one or more embodiments. In particular, the series of acts 1200 includes an act 1202 of generating a super-pixel image from a sample digital image. For example, the act 1202 involves downsampling a sample digital image to generate a super-pixel image. Further, the series of acts 1200 includes an act 1204 of generating a modified super-pixel image. For example, the act 1204 involves using a pixel dropping strategy to generate a modified super-pixel image. Further, the series of acts 1200 includes an act 1206 of generating a predicted noise vector. For example, the act 1206 involves a diffusion neural network generating a predicted noise vector of a digital image. Further, the series of acts 1200 includes an act 1208 of modifying parameters of a diffusion neural network. For example, the act 1208 involves comparing the predicted noise with the ground truth noise and modifying the parameters of the diffusion neural network accordingly.

In some embodiments, the series of acts 1200 includes generating a super-pixel image from a sample digital image; generating a modified super-pixel image by dropping a set of super-pixels from the super-pixel image according to a pixel dropping algorithm; generating a predicted noise vector by using a diffusion neural network to process a noisy digital image conditioned on the modified super-pixel image; and modifying parameters of the diffusion neural network based on comparing the predicted noise vector with an actual noise vector added to the noisy digital image.

In some embodiments, the series of acts 1200 includes downsampling the sample digital image into a grid of super-pixels; and upsampling the grid of super-pixels to an initial resolution of the sample digital image using nearest neighbor interpolation.

In some embodiments, the series of acts 1200 includes setting, within super-pixel image, color values for the set of super-pixels to a gray color value; and setting an alpha value of the diffusion neural network to zero for the set of super-pixels set to the gray color value.

In some embodiments, the series of acts 1200 includes selecting a size and a position for a shape enclosing the set of super-pixels within the super-pixel image; and dropping the set of super-pixels enclosed by the shape using the pixel dropping algorithm.

In some embodiments, the series of acts 1200 includes selecting a size and a position for a shape enclosing super-pixels other than the set of super-pixels within the super-pixel image; and dropping the set of super-pixels outside of the shape using the pixel dropping algorithm.

In some embodiments, the series of acts 1200 includes performing, using the pixel dropping algorithm, a random walk that drops the set of super-pixels by randomly selecting super-pixels from the super-pixel image starting from an initial position.

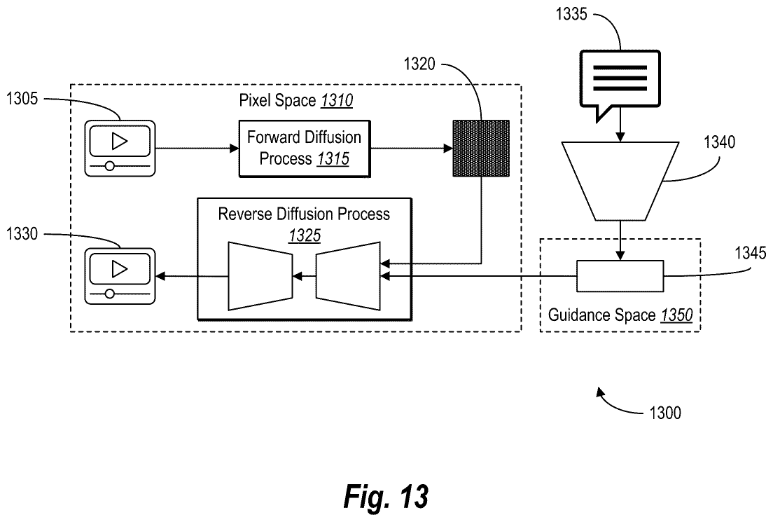

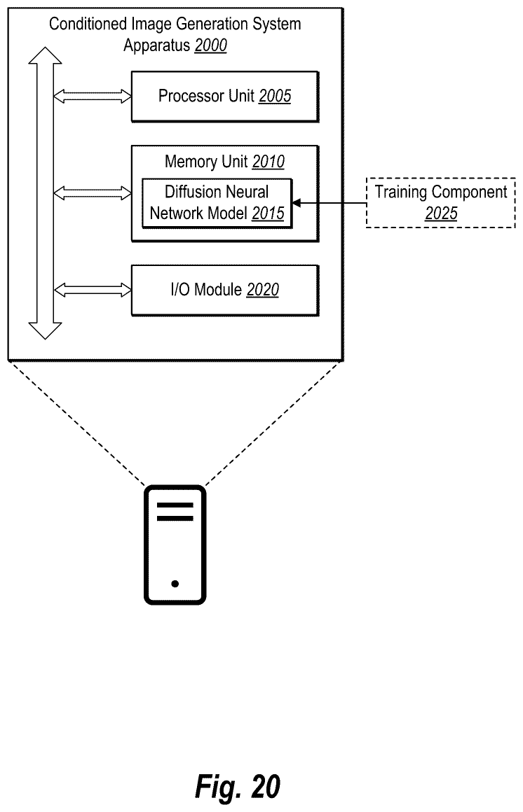

FIG. 13 shows an example of a guided diffusion model 1300 according to aspects of the present disclosure. In some examples, guided diffusion model 1300 describes the operation and architecture of the diffusion neural network model 2015 described with reference to FIG. 20. The guided diffusion model 1300 depicted in FIG. 13 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided diffusion model 1300 may take an original media item 1305 in a pixel space 1310 as input and apply forward diffusion process 1315 to gradually add noise to the original media item 1305 to obtain noisy media item 1320 at various noise levels.

Next, a reverse diffusion process 1325 (e.g., a U-Net) gradually removes the noise from the noisy media item 1320 at the various noise levels to obtain an output media item 1330. In some cases, an output media item 1330 is created from each of the various noise levels. The output media item 1330 can be compared to the original media item 1305 to train the reverse diffusion process 1325.

The reverse diffusion process 1325 can also be guided based on a text prompt 1335, or another guidance prompt, such as an image, a layout, a segmentation map, etc. The text prompt 1335 can be encoded using a text encoder 1340 (e.g., a multimodal encoder) to obtain guidance features 1345 in guidance space 1350. The guidance features 1345 can be combined with the noisy media item 1320 at one or more layers of the reverse diffusion process 1325 to ensure that the output media item 1330 includes content described by the text prompt 1335. For example, guidance features 1345 can be combined with the noisy features using a cross-attention block within the reverse diffusion process 1325.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

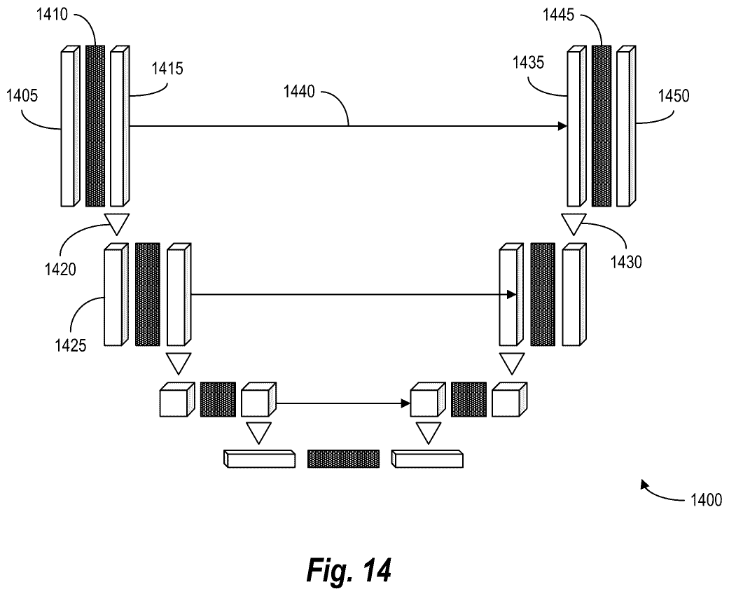

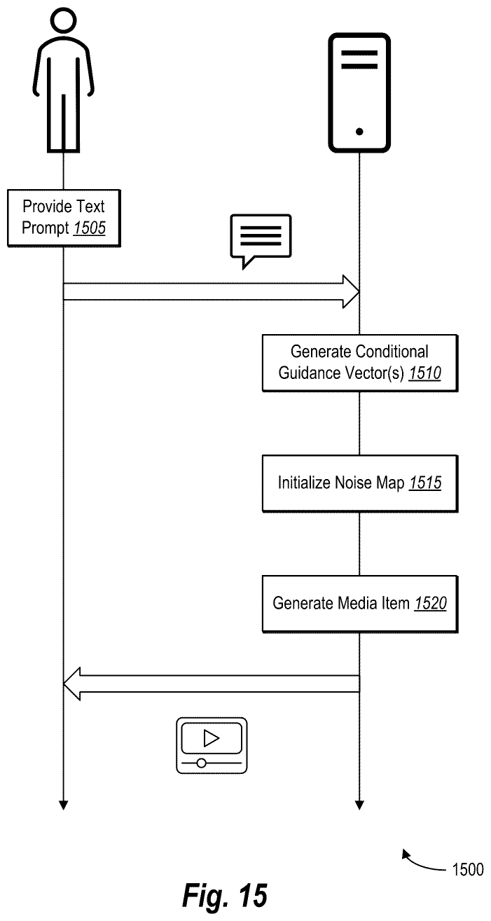

FIG. 14 shows an example of a U-Net 1400 according to aspects of the present disclosure. In some examples, U-Net 1400 is an example of the component that performs the reverse diffusion process 1325 of guided diffusion model 1300 described with reference to FIG. 13 and includes architectural elements of the diffusion neural network model 2015 described with reference to FIG. 20. The U-Net 1400 depicted in FIG. 14 is an example of, or includes aspects of, the architecture used within the reverse diffusion process described with reference to FIG. 15.

In some examples, diffusion models are based on a neural network architecture known as a U-Net. The U-Net 1400 takes input features 1405 having an initial resolution and an initial number of channels and processes the input features 1405 using an initial neural network layer 1410 (e.g., a convolutional network layer) to produce intermediate features 1415. The intermediate features 1415 are then down-sampled using a down-sampling layer 1420 such that down-sampled features 1425 features have a resolution less than the initial resolution and a number of channels greater than the initial number of channels.

This process is repeated multiple times, and then the process is reversed. That is, the down-sampled features 1425 are up-sampled using up-sampling process 1430 to obtain up-sampled features 1435. The up-sampled features 1435 can be combined with intermediate features 1415 having the same resolution and number of channels via a skip connection 1440. These inputs are processed using a final neural network layer 1445 to produce output features 1450. In some cases, the output features 1450 have the same resolution as the initial resolution and the same number of channels as the initial number of channels.

In some cases, U-Net 1400 takes additional input features to produce conditionally generated output. For example, the additional input features could include a vector representation of an input prompt. The additional input features can be combined with the intermediate features 1415 within the neural network at one or more layers. For example, a cross-attention module can be used to combine the additional input features and the intermediate features 1415.

FIG. 15 shows an example of a method 1500 for conditional media generation according to aspects of the present disclosure. In some examples, method 1500 describes an operation of the diffusion neural network model 2015 described with reference to FIG. 20 such as an application of the guided diffusion model 1300 described with reference to FIG. 13. In some examples, these operations are performed by a system including a processor executing a set of codes to control functional elements of an apparatus such as the media generation model described in FIG. 13.

Additionally or alternatively, steps of the method 1500 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1505, a user provides a text prompt describing content to be included in a generated media item. For example, a user may provide the prompt “a person playing with a cat”. In some examples, guidance can be provided in a form other than text, such as via an image, a sketch, or a layout.

At operation 1510, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 1515, a noise map is initialized that includes random noise. The noise map may be in a pixel space or a latent space. By initializing a media item with random noise, different variations of a media item including the content described by the conditional guidance can be generated.

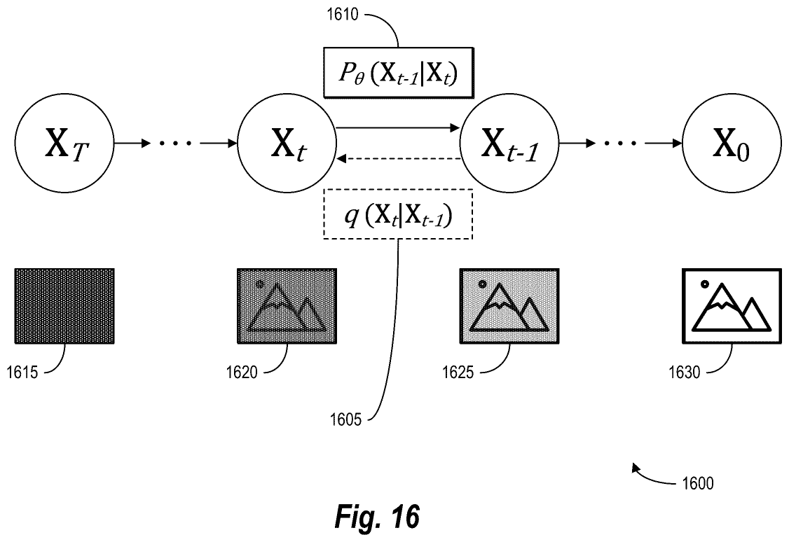

At operation 1520, the system generates a media item based on the noise map and the conditional guidance vector. For example, the media item may be generated using a reverse diffusion process as described with reference to FIG. 16.

FIG. 16 shows a diffusion process 1600 according to aspects of the present disclosure. In some examples, diffusion process 1600 describes an operation of the diffusion neural network model 2015 described with reference to FIG. 20, such as the reverse diffusion process 1325 of guided diffusion model 1300 described with reference to FIG. 13.

As described above with reference to FIG. 13, using a diffusion model can involve both a forward diffusion process 1605 for adding noise to a media item (or features in a latent space) and a reverse diffusion process 1610 for denoising the media item (or features) to obtain a denoised media item. The forward diffusion process 1605 can be represented as q(xₜ|xₜ₋₁), and the reverse diffusion process 1610 can be represented as p(xₜ₋₁|xₜ). In some cases, the forward diffusion process 1605 is used during training to generate media items with successively greater noise, and a neural network is trained to perform the reverse diffusion process 1610 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1610, the model begins with noisy data x_{T}, such as a noisy media item 1615 and denoises the data to obtain the p(xₜ₋₁|xₜ). At each step t−1, the reverse diffusion process 1610 takes xₜ, such as first intermediate media item 1620, and t as input. Here, t represents a step in the sequence of transitions associated with different noise levels, The reverse diffusion process 1610 outputs xₜ₋₁, such as second intermediate media item 1625 iteratively until x_{T} reverts back to x₀, the original media item 1630. The reverse process can be represented as:

$${p}_{θ} ( {x}_{t - 1} \vert {x}_{t} ) : = N ( {x}_{t - 1} ; {μ}_{θ} ( {x}_{t} , t ) , {Σ}_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {Π}_{t = 1}^{T} {p}_{θ} ( {x}_{t - 1} \vert {x}_{t} ) , \qquad ( 2 )$$

where p(x_{T})=N(x_{T}; 0, l) is the pure noise distribution as the reverse process takes the outcome of the forward process, a sample of pure noise, as input and

$${Π}_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

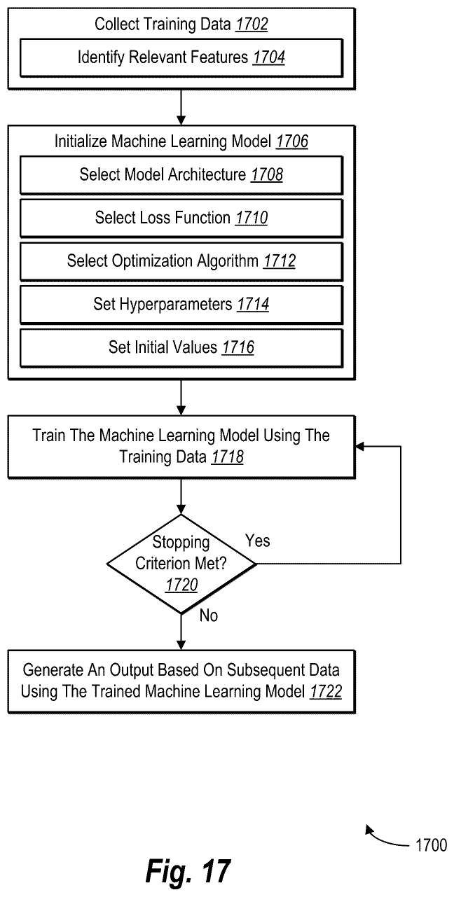

FIG. 17 is a flow diagram depicting an algorithm as a step-by-step procedure 1700 in an example implementation of operations performable for training a machine-learning model. In some embodiments, the procedure 1700 describes an operation of the training component 2025 described for configuring the diffusion neural network model 2015 as described with reference to FIG. 20. The procedure 1700 provides one or more examples of generating training data, use of the training data to train a machine-learning model, and use of the trained machine-learning model to perform a task.

To begin in this example, a machine-learning system collects training data (block 1702) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1704) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1706). Initialization of the machine-learning model includes selecting a model architecture (block 1708) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1710). The loss function is utilized to measure a difference between an output of the machine-learning model (i.e., predictions) and target values (e.g., as expressed by the training data) to be used to train the machine-learning model. Additionally, an optimization algorithm is selected (1712) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1716) examples of which includes initializing weights and biases of nodes to improve efficiency in training and computational resources consumption as part of training. Hyperparameters are also set (block 1714) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1718) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1720), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1720), the procedure 1700 continues training of the machine-learning model using the training data (block 1718) in this example.

If the stopping criterion is met (“yes” from decision block 1720), the trained machine-learning model is then utilized to generate an output based on subsequent data (block 1722). The trained machine-learning model, for instance, is trained to perform a task as described above and therefore once trained is configured to perform that task based on subsequent data received as an input and processed by the machine-learning model.

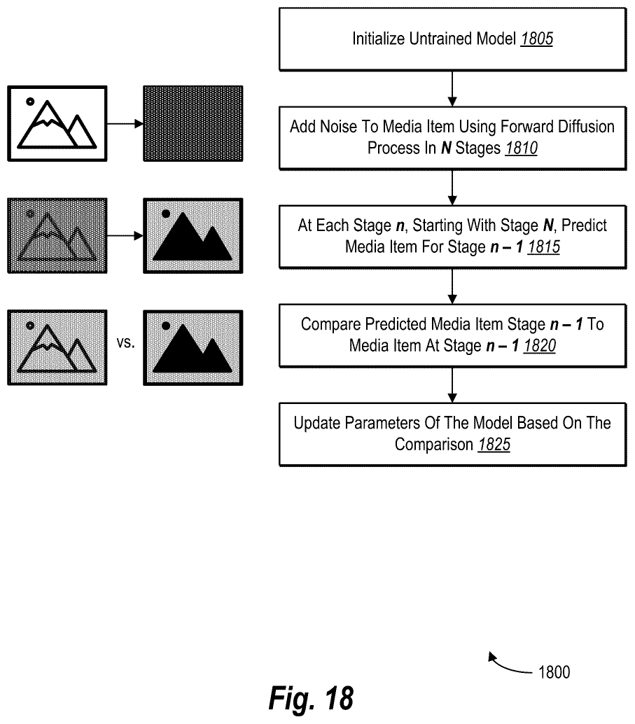

FIG. 18 shows an example of a method 1800 for training a diffusion model according to aspects of the present disclosure. In some embodiments, the method 1800 describes an operation of the training component 2025 described for configuring the diffusion neural network model 2015 as described with reference to FIG. 20. The method 1800 represents an example for training a reverse diffusion process as described above with reference to FIG. 16. In some examples, these operations are performed by a system including a processor executing a set of codes to control functional elements of an apparatus, such as the guided diffusion model described in FIG. 13.

Additionally or alternatively, certain processes of method 1800 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1805, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1810, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1815, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1820, the system compares predicted output (or features) at stage n−1 to an actual media item (or features), such as the output at stage n−1 or the original input. For example, given observed data x, the diffusion model may be trained to minimize the variational upper bound of the negative log-likelihood−log p_{θ}(x) of the training data.

At operation 1825, the system updates parameters of the model based on the comparison. For example, parameters of a U-Net may be updated using gradient descent. Time-dependent parameters of the Gaussian transitions can also be learned.

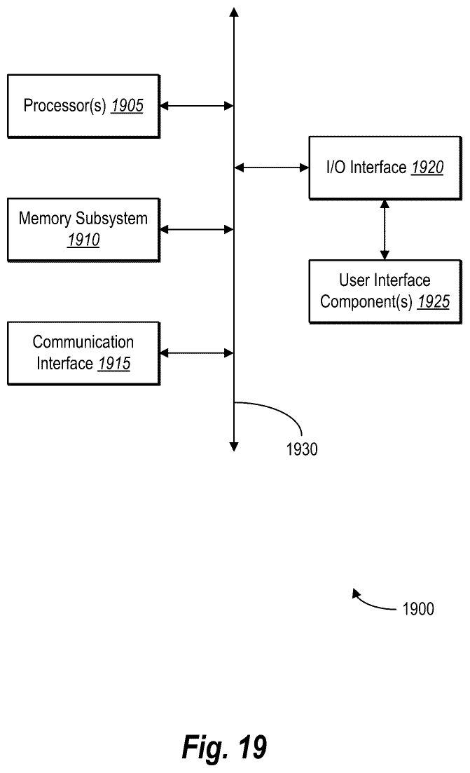

FIG. 19 shows an example of a computing device 1900 according to aspects of the present disclosure. The computing device 1900 may be an example of the conditioned image generation system apparatus 2000 described with reference to FIG. 20. In one aspect, computing device 1900 includes processor(s) 1905, memory subsystem 1910, communication interface 1915, I/O interface 1920, user interface component(s) 1925, and channel 1930.

In some embodiments, computing device 1900 is an example of, or includes aspects of, the media generation model of FIG. 13. In some embodiments, computing device 1900 includes one or more processors 1905 that can execute instructions stored in memory subsystem 1910 to perform media generation.

According to some aspects, computing device 1900 includes one or more processors 1905. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1915 operates at a boundary between communicating entities (such as computing device 1900, one or more user devices, a cloud, and one or more databases) and channel 1930 and can record and process communications. In some cases, communication interface 1915 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1920 is controlled by an I/O controller to manage input and output signals for computing device 1900. In some cases, I/O interface 1920 manages peripherals not integrated into computing device 1900. In some cases, I/O interface 1920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1920 or via hardware components controlled by the I/O controller.

According to some aspects, user interface component(s) 1925 enable a user to interact with computing device 1900. In some cases, user interface component(s) 1925 include an audio device, such as an external speaker system, an external display device such as a display screen, an input device (e.g., a remote-control device interfaced with a user interface directly or through the I/O controller), or a combination thereof. In some cases, user interface component(s) 1925 include a GUI.

FIG. 20 shows an example of an conditioned image generation system apparatus 2000 according to aspects of the present disclosure. Conditioned image generation system apparatus 2000 may include an example of, or aspects of, the guided diffusion model described with reference to FIG. 13 and the U-Net described with reference to FIG. 14. In some embodiments, conditioned image generation system apparatus 2000 includes processor unit 2005, memory unit 2010, diffusion neural network model 2015, I/O module 2020, and training component 2025. Training component 2025 updates parameters of the diffusion neural network model 2015 stored in memory unit 2010. In some examples, the training component 2025 is located outside the conditioned image generation system apparatus 2000.

Processor unit 2005 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 2005 is configured to operate a memory array using a memory controller. In other cases, a memory controller is integrated into processor unit 2005. In some cases, processor unit 2005 is configured to execute computer-readable instructions stored in memory unit 2010 to perform various functions. In some aspects, processor unit 2005 includes special purpose components for modem processing, baseband processing, digital signal processing, or transmission processing. According to some aspects, processor unit 2005 comprises one or more processors described with reference to FIG. 19.

Memory unit 2010 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 2005 to perform various functions described herein.

In some cases, memory unit 2010 includes a basic input/output system (BIOS) that controls basic hardware or software operations, such as an interaction with peripheral components or devices. In some cases, memory unit 2010 includes a memory controller that operates memory cells of memory unit 2010. For example, the memory controller may include a row decoder, column decoder, or both. In some cases, memory cells within memory unit 2010 store information in the form of a logical state. According to some aspects, memory unit 2010 is an example of the memory subsystem 1910 described with reference to FIG. 19.

According to some aspects, conditioned image generation system apparatus 2000 uses one or more processors of processor unit 2005 to execute instructions stored in memory unit 2010 to perform functions described herein. For example, the conditioned image generation system apparatus 2000 may generate synthesized digital images based on a color conditioning input and an image prompt.

The memory unit 2010 may include a diffusion neural network model 2015 trained to generate synthesized digital images based on a color conditioning input and an image prompt. For example, after training, the diffusion neural network model 2015 may perform inferencing operations as described with reference to FIGS. 15 and 16 to generate synthesized digital images based on a color conditioning input and an image prompt.

In some embodiments, the diffusion neural network model 2015 is an Artificial neural network (ANN) such as the guided diffusion model described with reference to FIG. 13 and the U-Net described with reference to FIG. 14. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of diffusion neural network model 2015 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 2025 may train the diffusion neural network model 2015. For example, parameters of the diffusion neural network model 2015 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 17 and 18). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the diffusion neural network model 2015 can be used to make predictions on new, unseen data (i.e., during inference).

I/O module 2020 receives inputs from and transmits outputs of the conditioned image generation system apparatus 2000 to other devices or users. For example, I/O module 2020 receives inputs for the diffusion neural network model 2015 and transmits outputs of the diffusion neural network model 2015. According to some aspects, I/O module 2020 is an example of the I/O interface 1920 described with reference to FIG. 19.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
receiving, from a client device, an image prompt comprising a text description of a digital image and a color conditioning input defining a position of a color value for the digital image;
generating, utilizing a diffusion neural network to process the image prompt and the color conditioning input, a synthesized digital image depicting content corresponding to the text description and comprising pixels reflecting the color value at the position; and
providing the synthesized digital image for display on the client device.

2. The method of claim 1, further comprising conditioning the diffusion neural network by processing the color conditioning input using a color control adapter.

3. The method of claim 1, wherein receiving the color conditioning input comprises receiving, from the client device, a condition image that depicts pixels in the color value at one or pixel coordinates defining the position.

4. The method of claim 1, wherein receiving the color conditioning input comprises receiving, from the client device, a condition image depicting:
pixels depicting a gray color value at one or more pixel coordinates defining the position; and
pixels depicting non-gray color values at pixel coordinates other than the one or more pixel coordinates defining the position.

5. The method of claim 1, wherein generating the synthesized digital image comprises:
detecting edges depicted in the digital image using an edge detection neural network; and
conditioning synthesis of the diffusion neural network using the edges together with the color conditioning input.

6. The method of claim 1, wherein receiving the color conditioning input comprises receiving a condition image of a design template depicting the color value at the position.

7. The method of claim 1, wherein generating the synthesized digital image further comprises:
receiving, from the client device, the color conditioning input comprising a text design element;
generating a padded text effect, wherein generating the padded text effect comprises padding edges depicted in the text design element using an edge detection neural network; and
conditioning synthesis of the diffusion neural network using the padded text effect together with the color conditioning input.

8. A system comprising:
a memory component; and
one or more processing devices coupled to the memory component, the one or more processing devices to perform operations comprising:
receiving, from a client device, an image prompt comprising a text description of a digital image and a color conditioning input defining a position of a color value for the digital image;
modifying a diffusion neural network by injecting the color conditioning input into layers of the diffusion neural network using a color control adapter;
generating, utilizing the diffusion neural network conditioned on the color conditioning input, a synthesized digital image depicting content corresponding to the text description and comprising pixels reflecting the color value at the position; and
providing the synthesized digital image for display on the client device.

9. The system of claim 8, wherein modifying the diffusion neural network comprises transforming, using the color control adapter, the color conditioning input according to a pixel dropping function.

10. The system of claim 9, wherein transforming the color conditioning input comprises:
dropping, using the color control adapter, one or more super-pixels not depicting the color value within the color conditioning input according to a first pixel dropping function; or
dropping, using the color control adapter, one or more super-pixels depicting the color value within the color conditioning input according to a second pixel dropping function.

11. The system of claim 8, wherein:
receiving the color conditioning input comprises receiving a template image with a text region and a color scheme; and
generating the synthesized digital image comprises generating, using the diffusion neural network, synthesized pixels according to the color scheme and the text region of the template image adapted to the image prompt.

12. The system of claim 11, wherein generating the synthesized digital image further comprises:
generating, from the template image, a super-pixel image reflecting the color scheme; determining intersected super-pixels within the super-pixel image that intersect the text region of the template image; and
generating the synthesized digital image using the diffusion neural network conditioned on the intersected super-pixels.

13. The system of claim 8, wherein the operations further comprise generating a modified color conditioning input by:
converting the color conditioning input from a first color space to a second color space that defines a luminance parameter of the color conditioning input; and
modifying the color conditioning input by injecting jitter into the luminance parameter.

14. The system of claim 13, wherein the operations further comprise generating an additional synthesized digital image utilizing the diffusion neural network conditioned on the modified color conditioning input.

15. A non-transitory computer readable medium comprising instructions that, when executed by at least one processor, cause a computing device to perform operations comprising:
generating a super-pixel image from a sample digital image;
generating a modified super-pixel image by dropping a set of super-pixels from the super-pixel image according to a pixel dropping algorithm;
generating a predicted noise vector by using a diffusion neural network to process a noisy digital image conditioned on the modified super-pixel image; and
modifying parameters of the diffusion neural network based on comparing the predicted noise vector with an actual noise vector added to the noisy digital image.

16. The non-transitory computer readable medium of claim 15, wherein generating the super-pixel image comprises:
downsampling the sample digital image into a grid of super-pixels; and
upsampling the grid of super-pixels to an initial resolution of the sample digital image using nearest neighbor interpolation.

17. The non-transitory computer readable medium of claim 15, wherein dropping the set of super-pixels comprises:
setting, within super-pixel image, color values for the set of super-pixels to a gray color value; and
setting an alpha value of the diffusion neural network to zero for the set of super-pixels set to the gray color value.

18. The non-transitory computer readable medium of claim 15, wherein generating the modified super-pixel image comprises:
selecting a size and a position for a shape enclosing the set of super-pixels within the super-pixel image; and
dropping the set of super-pixels enclosed by the shape using the pixel dropping algorithm.

19. The non-transitory computer readable medium of claim 15, wherein generating the modified super-pixel image comprises:
selecting a size and a position for a shape enclosing super-pixels other than the set of super-pixels within the super-pixel image; and
dropping the set of super-pixels outside of the shape using the pixel dropping algorithm.

20. The non-transitory computer readable medium of claim 15, wherein generating the modified super-pixel image comprises performing, using the pixel dropping algorithm, a random walk that drops the set of super-pixels by randomly selecting super-pixels from the super-pixel image starting from an initial position.
